(19) United States
(12) Patent Application Publication
(10) Pub. No.: US 2011/0198436 A1
(43) Pub. Date: Aug. 18, 2011

(54) Vehicle capable of driving on land, air or water

(76) Inventors: Guowen Liu, Cary, NC (US); Wanbing W. Liu, Cary, NC (US); Quanwen Liu, Shi-Jia-Zhuang (CN)

(21) Appl. No.: 13/066,672

(22) Filed: Apr. 21, 2011

(30) Foreign Application Priority Data
Sep. 30, 2009 (CN) PCT/CN2009/074357

(51) Int. Cl. B64C 39/08; B60F 3/00

(52) U.S. Cl. 244/19; 440/12.5

(57) ABSTRACT

A vehicle capable of driving on land, air or water comprises of a fuselage (1), a main engine or a main motor, and a power control and transmitting system. A main shaft (2) is provided at two sides of the fuselage. Blade sleeves (6) are fixed to the main shafts. Blade handles (7) capable of spinning around own axes are mounted on the blade sleeves. Blades are fixed to the blade handles. Blade open-close devices are installed on the fuselage and/or on the main shafts to control the blades to rotate relative to the blade sleeves and the main shafts. The blade open-close device is a mechanism that can open and close the blades once a cycle of rotating along with the main shaft. When opened, blades' broad flat surfaces are parallel or generally parallel with the main shafts. When closed, the blades' broad flat surfaces are perpendicular or generally perpendicular to the main shafts. The present invention can offer lift and propulsion force through controlling the opening and closing of the blades rotating in vertical planes parallel to the fuselage.

### CROSS-REFERENCE TO RELATED APPLICATIONS

This application claims the priority, under 35 USC §§119 of International application No. PCT/CN2009/074357, filed Sep. 30, 2009 with a priority date of Oct. 24, 2008 and a priority No. 200810079640.0 (CN), which designated the United State of America; this application has a prior Chinese patent No. 200820106301.2 (CN) filed on Oct. 24, 2008, and a prior Chinese patent application No. 200810079640.0 (CN) filed on Oct. 24, 2008; the prior applications are herewith incorporated by reference in their entirety.

### FIELD OF THE INVENTION

The present invention relates to a transportation vehicle, and more particularly to a vehicle that can travel on land, in air and/or in water.

### BACKGROUND OF THE INVENTION

There are so far mainly two kinds of aircrafts, one kind is fixed-wing aircraft and the other kind is rotary-wing aircraft. The fixed-wing aircrafts that we usually can see are passenger airplanes and cargo airplanes in airlines. Its advantage is that by ejecting hot air from burning fuel, a fixed-wing aircraft has a very powerful propulsion system and can reach a higher speed and carry more weight. However, to take off it needs to reach a high-enough forward horizontal speed first and then by lifting its head up, the fuselage and wings will form a positive angle with a horizontal plane and thus can gain a lift by the interaction between its tilted fuselage and wings and air. To reach a high-enough forward horizontal speed, the aircraft needs a certain time and distance to accelerate itself. Therefore, a fixed-wing aircraft usually needs a long track to take off. Similarly, since when its speed is too low it cannot get enough lift and will start to fall quickly. To land in a smaller downward speed, a fixed-wing aircraft needs to keep a relatively high horizontal speed before landing. Therefore, a fixed-wing aircraft needs a long track to land so that it can gradually decelerate itself to stop. In addition, a fixed-wing aircraft also has low energy efficiency in producing lift or forward thrust.

The rotary-wing aircrafts so far are mainly helicopters. A helicopter can gain lift by rotating its tilted rotors in a horizontal plane or in a conical plane close to a horizontal plane. Since in this way it can gain lift without getting a forward speed, a helicopter doesn't need a track. Since only needing a small area for landing and taking off, helicopters have been widely used in emergency needs in places that have no track or cannot have tracks. Due to their characteristic of flying in low speed or even staying still in air, helicopters are also good tools for measuring, surveying, detecting, and entertaining. However, helicopters also have some disadvantages, such as low energy efficiency, loud noise and low loading capacity. These disadvantages result from the working principle of theirs rotary blades in producing thrust. To gain upward thrust, a rotary blade rotating in a horizontal plane need to have its facing down blade surface to form an angle with a horizontal plane so that by attacking air it can receive a reaction upward and perpendicular to its surface. However, only a component of the reaction is vertically upward reaction, and the other component of the reaction is a horizontal resistant force perpendicular to the radius of the blade. This horizontal resistant force wastes energy. This energy waste can only be reduced by reducing the angle that the blade forms with a horizontal plane. However, reducing this angle will reduce the air-attacking area and air-attacking speed of the blade, causing a reduction of lift. In such a circumstance, to maintain a certain lift it is necessary to increase the rotation speed of the blade. However, the rotation speed of the engine cannot be increased unlimitedly and, a large increase of the rotation speed of the blade also causes a rapid increase of many kinds of frictions and resistances (mechanically and from the air), thus resulting in energy wastes from other sources. An increase of the rotation speed of the blade also causes an increase of noise. Therefore, theoretically, helicopters can neither increase their energy efficiency by reducing energy waste, nor reduce their noise.

On the other hand, to obtain a forward thrust, a helicopter needs to tilt its blades' rotation plane forward so that the total thrust obtained from air changes from a vertically upward direction to an upward-and-forward direction. Such an upward-and-forward total thrust can provide a horizontal forward thrust. In this manner, a helicopter can gain forward thrust, but at the cost of some upward thrust. In this condition, to maintain its original lift, the helicopter has to either increase the angle between its blades and a horizontal plane or to increase the rotation speed of its blades, both reducing its energy efficiency in producing thrust. Therefore, under a fixed power of its engine, if a helicopter wants to fly in a high speed, it will have to reduce its load, thus having its speed and load both limited.

### DESCRIPTION OF THE INVENTION

A primary object of the present invention is to provide a vehicle that not only has the advantage of taking off and landing vertically as a helicopter, but also can gain lift and forward thrust in a more reasonable and scientific way. Different from a helicopter, which rotates its tilted blades in a horizontal plane or in a conical surface close to a horizontal plane, the vehicle provided by the present invention rotates its straight flat blades in vertical or nearly vertical planes.

The present invention is achieved as: a vehicle capable of moving on land, in air and/or in water, comprises at least a fuselage, a main engine or main electric engine and a power control and transmitting system. On both sides of the fuselage there are main shafts stretching out. The main shafts have blade sleeves fixed on them. Blade sleeves have blade handles installed in/on them in a way that the blade handles can spin around their own central axes. On blade handles there are blades fixed on them. On the fuselage and/or main shafts, there are blade open-close devices installed which can control the blade handles and the blades to spin relative to the blade sleeves and the main shafts. Blade open-close devices are devices that can make blades open and close once during each cycle the blades rotate along with their main shafts. When opened, blades have their broad flat surfaces lying within planes parallel or nearly parallel to the main shafts. When closed, blades have their broad flat surfaces lying within planes perpendicular or nearly perpendicular to the main shafts.

Under the above technique plan, the present invention can be achieved as:

The above said blade open-close devices comprise at least controlled gears and controlling gears. The controlled gears are gears fixed on blade handles or gears that are connected with these gears through chain-like structures. The controlling gears are teethed ring-shaped structures installed on the fuselage, perpendicular to and surrounding main shafts and having teeth covering a whole circle region on their surfaces. The controlled gears are contacting and in mesh with the controlling gears, and the teeth numbers of the controlling gears are one second of those of their corresponding gears fixed on blade handles.

The above said blade open-close devices comprise at least controlled gears and controlling gears. The controlled gears are gears fixed on blade handles or other gears that are connected with these gears through chain-like structures. The controlling gears are gears on the surfaces of ring segment-shaped structures installed on the fuselage and perpendicular to main shafts. When the blades rotate along with their main shaft to pass a controlling gear, a controlled gear can contact and be in mesh with the controlling gear. The teeth number of each controlling gear is one fourth of that of its corresponding gear fixed on a blade handle.

The above said blade open-close device comprises at least a gear fixed on a blade handle, a pushing bar fixed at an eccentric point on this gear or on another gear that is connected with this gear through a chain-like structure and rotatable around the fixation point, and a raised ring segment installed on one side of the fuselage. When the pushing bar rotates to the position of the raised ring segment, one end of the pushing bar can contact the raised ring segment.

The above said blade open-close device comprises at least an electric motor or an electromagnet, one or two or more ring segment-shaped parallel switches controlling the circuit of the above electric motor or electromagnet and fixed on a blade handle or on a switch handle which is connected with a blade handle through a chain-like structure, and a conductive track(s) that are conductive, installed on one side of the fuselage and in ring-segment shape. When the above blade handle or switch handle rotates along with its main shaft to the location of a conductive track, the switch facing the conductive track can contact it and make the circuit of the electric motor or electromagnet get connected.

The above said blade open-close devices comprise at least an electric motor or an electromagnet, two or more switch buttons controlling the circuit of the electric motor or electromagnet and fixed on a blade handle or on a switch handle which is through a chain-like structure connected with a blade handle and rotates with this blade handle, and a pressing ring segment(s) or pressing button(s) installed on one side of the fuselage and using its main shaft as their circle center. When the switch handle rotates along with its main shaft to the location of a pressing ring segment or a pressing button, the switch button facing the pressing ring segment or button can contact the pressing ring segment or button and trigger a switch, making the circuit of the electric motor or electromagnet change its connection status or current direction.

The above said blade open-close devices comprise at least an electric motor or an electromagnet, one or two or more parallel light-inducible or sound-inducible switch or one or two or more light-receiving or sound-receiving window of a light-inducible or sound-inducible switch controlling the circuit of the electric motor or electromagnet and fixed on a blade handle or on a switch handle which is connected with a blade handle through a chain-like structure and rotates with this blade handle, and a light-producing or sound-producing ring segment(s) installed on one side of the fuselage. When the blade handle or switch handle rotates along with its main shaft to the location of one of the light-producing or sound-producing ring segments, the inducible switch or the receiving window directly facing this light-producing or sound-producing ring segment can receive the inducing signal emitted from the light-producing or sound-producing ring segment and make the circuit of the electric motor or electromagnet get connected.

On the fuselage of the vehicle provided by the present invention there can be two or more main shafts installed. The blades on some of the main shafts open in an angle region surrounding a horizontal plane and by adjusting the rotational speed and direction of these main shafts the magnitude and direction of the vertical thrust gained by the vehicle can be controlled. The blades on other main shafts open in an angle region surrounding a vertical plane and by adjusting the rotational speed and direction of these main shafts the magnitude and direction of the horizontal thrust gained by the vehicle can be controlled.

In the vehicle provided by the present invention, when there are multiple blades carried by a main shaft, two or more of the blades can open at the same time. After they get opened, two adjacent edges of two blades next to each other should overlap or seal with each other or have a gap less than 10% of the width of a blade.

In a vehicle provided by the present invention, a device that adjusts the blade open-region and/or close-region is a vertical ring installed on one side of the fuselage through bearing structures and using a main shaft as its circle center. On the inner side of the ring there is a phase gear fixed on it and using the same main shaft as its circle center as the ring. The phase gear is controlled directly or through a chain structure by a driving gear.

In a vehicle provided by the present invention, it can only have devices to open blades. The closing of the blades is achieved through the blades' interaction with air or by forces from springs.

The vehicle provided by the present invention gains lift and forward thrust still by the way that attacking surrounding air with its rotating blades to receive reaction, but different from a helicopter, this vehicle's main shafts which carry blades to rotate are installed, not vertically stretched up, but horizontally stretched out toward two sides of the fuselage. This vehicle's blades rotate around the axes of the horizontally positioned main shafts and in vertical planes parallel to the longitude axis of the fuselage, instead of around the axis of the vertically positioned main shafts and in a horizontal plane or a conical surface close to a horizontal plane. Moreover, to gain a upward and/or forward thrust, the broad flat surface of a rotating blade, instead of maintaining a 0°-60° angle with the direction of the blade's velocity, but forms a 90° or close to 90° (85°-95°) angle with the direction of the blade's velocity to attack air. To distinguish it from the screw blade in a helicopter, the blade that attacks air (or other media) in this way (the angle between the broad flat surface of the blade and the direction of the blade's velocity is 90° or close to 90°) can be called a straight blade.

When the fuselage is still in relation to the surrounding air (or any other medium), the net thrust produced by a straight blade is averaged zero in each cycle of rotation. To gain a non-zero net thrust from the outside by rotating its blades, the vehicle needs to make its blades close at some regions of their rotation cycle and open at some other regions of their rotation cycle. To close a blade means to make the broad flat surface of the blade have an angle of 0° or about 0° with the direction of the blade's velocity. To open a blade is to make the broad flat surface of the blade have an angle of 90° or about 90° with the direction of the blade's velocity. For this purpose, as it rotates around the main shaft that carries it, a blade also needs to spin along its blade handle from time to time to make itself open and close at different regions of every rotation cycle. Lift and forward thrust is just gained by the selective opening and closing of the blades rotating around main shafts. In the present invention, the straight blade that can not only rotate around its main shaft but also spin around its blade handle is called a rotating-spinning straight blade.

Briefly to say, to gain a net upward thrust, a blade becomes open to attack air only when it is rotating downwards, and becomes closed to reduce interaction with air when it is rotating upwards. Similarly, to gain a forward thrust, the blade becomes open to attack air only when it is rotating backwards, and becomes closed to reduce its interaction with air when it is rotating forwards (as shown in FIG. 1). A main shaft that carries the blades can rotate clockwise or counter-clockwise. To make the description simpler and easier to understand, here and in the following parts of this invention, unless otherwise stated we only use the clockwise rotation of the main shaft (viewed from the far end of the main shaft to the end connected to the fuselage) as an example to explain the principle and embodiments of this invention. Since counter-clockwise rotation works similarly to clockwise rotation, the vehicle provided by the present invention is not limited to clockwise rotation of its main shafts, but also includes counter-clockwise rotation.

To describe easily, in the present invention the position of a blade when rotating around its main shaft is described by the angle formed by the radial line of the blade (i.e. the axis of the blade handle, which is perpendicular to the main shaft and pointing from the main shaft to the blade) with a horizontal plane that contains the main shaft. This angle is called a “blade angle” and labeled as “a” in this invention. When the radial line of the blade is overlapped with the horizontal plane (i.e. when the blade is horizontal and points toward the front of the fuselage), the blade angle is 0° or an integer of 360°. The blade angle increases (or is positive) as the blade revolves to the direction to which its main shaft rotates (clockwise) and decreases (or is negative) as the blade revolves to the opposite direction.

In this way, in every rotation cycle, if the blade opens only in an angle region of α=−90°-+90° or a smaller region within this region, the vehicle will gain a net thrust upward. If the blade opens only in an angle region of α=0°-+180° or a smaller region within this region, the vehicle will gain a net thrust forward.

As shown in FIG. 1, the upward component of the force that a rotating blade received from surrounding air is: F_{y}=F cos α, whereas F is the total reaction that the blade receives from the surrounding air. When blade angle α=0°, all the total reaction force is upward and all the energy the blade used to attack surrounding air is transformed into lift. Thus at this position the vehicle has a 100% theoretical energy efficiency in producing lift.

If the blade opens in a blade angle region of α1 to α2 during each rotation cycle, the average lift that the blade gets in this region is: F_{y}=F (sin α₁−sin α₁)/(α₂-−₁).

In this case, the vehicle's energy efficiency in producing lift is:

η(l)=(sin α₁−sin α₁)/(α₂−α₁).

Using this formula we can calculate that when the blade opens in the blade angle region of −15° to +15° (α₁=−15°, α₂=15°) (an angle of 30°), its energy efficiency in producing lift is about 0.989; when the blade opens in the blade angle region of −30° to +30° (an angle of 60°), its energy efficiency in producing lift is about 0.955; when the blade opens in the blade angle region of −15° to +45° (an angle of 60°), its energy efficiency in producing lift is about 0.922; when the blade opens in the blade angle region of −45° to +45° (an angle of 90°), its energy efficiency in producing lift is about 0.900; when the blade opens in the blade angle region of −30° to +60° (an angle of 90°), its energy efficiency in producing lift is about 0.870; when the blade opens in the blade angle region of −45° to +60° (an angle of 105°), its energy efficiency in producing lift is about 0.870; when the blade opens in the blade angle region of −60° to +60° (an angle of 120°), its energy efficiency in producing lift is about 0.827; when the blade opens in the blade angle region of −30° to +90° (an angle of 120°), its energy efficiency in producing lift is about 0.716; when the blade opens in the blade angle region of −60° to +90° (an angle of 150°), its energy efficiency in producing lift is about 0.713; when the blade opens in the blade angle region of −90° to +90° (an angle of 180°), its energy efficiency in producing lift is about 0.637.

To have a higher energy efficiency, when the vehicle only needs lift (such as to take off or to stay still in the air), its rotating blades should open in a smaller region around α=0° in every rotation cycle. However, to maintain a certain amount of lift, the effect of a smaller opening region on reducing lift will need a higher rotation speed of the blades to compensate. Fortunately, the above calculation shows that even the blade opens in a quite big angle region, the energy efficiency on producing lift can still be very close to 1. For example, if the blade opens in between −45°-+45°, its efficiency in producing lift is about 0.900 (i.e. 90%). Therefore, the blade of the vehicle provided in the present invention only needs to rotate in a relatively slow speed to produce lift, thus significantly reducing other resistances and frictions. If several blades are used side by side, the area at which the blades strike the air will be increased several times, making the striking area several or tens of times of the striking area of the blades in a helicopter. In this way, to get the same amount of lift, the blades of the vehicle provided in the present invention only need to rotate in a speed of tenths or less than tenths of the blade rotation speed of a helicopter, significantly reducing resistances and frictions from any other sources.

Similarly, the forward thrust of the total thrust (the total reaction from surrounding air) obtained by a blade provided by this invention is: F_{X}=F sin α. At the position where the blade angle α is 90°, the total thrust is all forward thrust, making the energy efficiency in producing forward thrust be 1. If the blade opens in between blade angle α₁ and α₂ in every rotation cycle, the average forward thrust obtained in this region is:

Fₓ=F(cos α₁−cos α₂)/(α₂−α₁).

If the blade opens in a blade angle region of α=+30°-+135° or a smaller region within it, the vehicle carrying the blade can gain forward thrust.

If the blade opens in an angle region of α=+45°-+135° (a 90° angle), the energy efficiency in producing forward thrust will be 0.900.

If both lift and forward thrust are needed, the blade can open in a blade angle region of α=−60°-+150° or a smaller region within it (e.g. −30°-+120°).

If the blade opens in an angle region of α=0°-+90°, the reaction it received from air can be used either for lift or for forward thrust. Therefore, if both lift and forward thrust are fully utilized, the energy efficiency in producing required thrusts will be 1 in this region. This is the best opening region for the blade to provide both lift and forward thrust at the same time.

In the angle region of α=−90°-0°, the blade can open to get lift but at the same time will also gain a backward thrust. Such a backward thrust will cancel the forward thrust from other opening region (0°-+180° or a smaller region within it), and thus can reduce the energy efficiency. The closer to −90° the blade opens, the bigger the backward thrust being produced and also the lower the energy efficiency in producing lift. On the contrary, the closer to 0° the blade opens, the smaller the backward thrust being produced and also the higher the energy efficiency in producing lift. Therefore, if both lift and forward thrust are needed, the blade should open in a smaller angle region close to 0° within this angle region (−90°-0°), for example, a region from −30° to 0°, or smaller.

In the angle region of α=90°-180°, the blade can open to get forward thrust but at the same time will gain downward thrust, instead of lift. Such a downward thrust will cancel the lift from other opening region (−90°-+90° or a smaller region within it), and thus can reduce the energy efficiency. The closer to 180° the blade opens, the bigger the downward thrust being produced and also the lower the energy efficiency in producing forward thrust. The closer to 90° the blade opens, the smaller the downward thrust being produced and also the higher the energy efficiency in producing forward thrust. Therefore, if both lift and forward thrust are needed, the blade should open in a smaller angle region close to 90° within this angle region, for example, a region from 120° or smaller. Combined with the above, when both lift and forward thrust are needed, the blade should open in the angle region of −30°-+120° or a smaller region within it.

In the angle region of α=180°-270°, the blade can open to get neither a lift nor a forward thrust, but a downward thrust and a backward thrust. However, such a downward thrust or a backward thrust can sometimes turn to be very useful. A downward thrust can be used for a quick drop or landing and a backward thrust can be used for braking or driving backwardly. A backward thrust can be more practically useful than a downward thrust, since a quick drop or landing can usually be fulfilled by gravity, but a quick deceleration or a backward drive needs to be carried out by a backward thrust. The angle region of α=180°-360° or smaller, especially the region of 240°-300°, is the best region for the blade to open to gain backward thrust.

As mentioned above, if the blade opens in an angle region of α₁-α₂, the average forward thrust it can get in this region is:

Fₓ=F(cos α₁−cos α₂)/(α₂−α₁).

This indicates that if the position where the blade opens (α₁=−α) is symmetric to the position where the blade closes (α₂=+α) along a horizontal plane, the net forward thrust the blade gets in every rotation cycle will be zero. To get a positive forward thrust, it is necessary to have cos α₁−cos α₂>0. This means that if α₁ is within the range of −90°-0°, α₂ is within the range of 0°-90°, it is necessary to have the absolute value of α₂ bigger than that of α₁ to get a net positive forward thrust.

The above calculations and discussions are made assuming the speed of the vehicle is zero, thus only valid when the vehicle is taking off or staying still in the air. They can also be applied to low speed conditions with a good approximation.

When the vehicle flies at a high speed, calculations and discussions about the thrust the blade can get will be complicated. At first, if the vehicle has a horizontal flying speed, when the opening position and the closing position of the blade are symmetric about axis x (or a horizontal plane) (i.e. the blade opens at −α and closes at +α), the net forward thrust will no longer be zero, but a negative value, thus being a backward thrust. This is because when the vehicle is still, the backward thrust its blade gains at the region of −α-0° equals the forward thrust the blade gains at the region of 0°-+α, making the total forward thrust be zero. However, when the vehicle is flying at a high speed (its horizontal speed is V), in the region of −α-0°, the blade will attack air with an extra horizontal speed V in addition to its rotation speed (in relation to the main shaft or the fuselage), causing the blade to gain a backward thrust bigger than the backward thrust it would otherwise gain when the vehicle is still; and in the region of 0°-+α, the blade will attack air with a speed which is its rotation speed (in relation to the main shaft or the fuselage) minus the horizontal speed V, thus a less speed, causing the blade to gain a forward thrust smaller than the forward thrust it would gain when the vehicle is still. Therefore, when the vehicle is flying in a high horizontal speed, if the blade keeps open in the region of −α-+α the thrust the blade gains will not be zero horizontally, but a backward thrust. In order to gain the same forward thrust as it flies in a lower speed, a vehicle flying in a high speed needs to open or (and) to close its blade at a later time.

From the above analysis, it is easy to see that no matter whether it is in regard to the energy efficiency of such a vehicle, or to controlling the vehicle for ascending, descending, moving forward and moving backward, or to adjusting the lift or forward thrust smoothly to any desired amount under any flying speed, a precise and flexible control of the opening and closing of the blade is crucial for realizing the above ideas and principles into a practical vehicle. In the present invention, the device that controls the opening and closing of the blade(s) is called a blade open-close device.

In the present invention, a main shaft is an axle that can rotate when driven by a main engine (in this invention, a main engine is the most powerful engine in the vehicle), is installed on a fuselage through bearings or any other structure that allows low-friction rotation, is positioned horizontally and points toward one of the two sides of the fuselage. A blade sleeve is a rod-shaped, tube-shaped or block-shaped structure and/or any combination structure of the above two or three and is directly fixed on and rotates with a main shaft. A blade handle is a rod-shaped, tube-shaped and/or partly rod-shaped and partly tube-shaped structure that is installed on/in a blade sleeve and can spin around an axis (usually is the axis of itself and/blade sleeve, which is perpendicular to the main shaft that carries it). A blade is a sheet-shaped structure that is fixed on a blade handle or is made into a whole structure with a blade handle. A blade open-close device is a device that controls a blade(s) and a blade handle(s) to spin in relation to a blade sleeve and a main shaft.

From the above definitions and descriptions we can see that in a working status, driven by the main engine, main shafts carries blade sleeves, blade handles and blades to rotate (called public rotation in the present invention). At the same time, under the control of blade open-close devices, blades and blade handles can also rotate around the axes of the blades or blade handles (called spinning in the present invention).

A main shaft positioned horizontally and pointing to the two sides of the fuselage can be perpendicular to the fuselage (i.e. the longitudinal middle axis of the fuselage, which is an axis from the rear to the front and in the middle of the fuselage) or not. The main shaft(s) at the left side and the main shaft(s) at the right side of the fuselage can be symmetric to each other or not.

To make the description easy and simple, we will hereafter only use a special case as an example to describe, where the main shafts are all perpendicular to the fuselage, and the main shaft(s) at the left side and the main shaft(s) at the right side of the fuselage are symmetric to each other along the fuselage. However, the present invention should not be limited to this. It also includes other cases such as the main shaft(s) is not perpendicular to the fuselage and/or the main shafts are not left-right symmetric. In this invention, a pair of main shafts symmetric along and perpendicular to the fuselage can be formed by extending a main shaft to both sides of the fuselage, but to prevent confusion, in such a case they will still be called two main shafts or two left-right symmetric main shafts in this invention.

A vehicle provided in the present invention can have one main shaft, two main shafts (one at the left and one at the right) or more than two main shafts. The main shafts can be positioned at the same or close to same height as the weight center of the vehicle and can also be positioned well above the weight center of the vehicle. When the main shafts are significantly or very well above the weight center of the vehicle, it will be far from the ground, thus allowing the installation of blades with a big radius. In addition, when there are two or more main shafts are used in a vehicle, these main shafts can be positioned at the same height or at different heights. For instance, when four main shafts are used, two of them can be at front (one at left and the other at right) and be lower than the two at rear or, alternatively, the two at front are higher than the two at rear. In the present invention, a main shaft and all the accessories installed on it (such as blade(s) and blade handle(s), etc.) is called a rotating-spinning rotor. The rotating-spinning rotors of a vehicle can work in the same pace and have same or similar function, but can also work independently to each other and have different functions. For example, if a vehicle has four rotating-spinning rotors, it can be designed in a way that the front pair (one at the left and the other at the right of the fuselage) of rotors only produces lift, while the rear pair of rotors only produces forward or backward thrust. Or oppositely, the rear pair (one at the left and the other at the right of the fuselage) is only responsible for producing lift and the front pair only for providing forward or backward thrust.

There can be one, two or more than two blades carried by each main shaft. To reduce air resistance received by a blade when it is closed, the thickness of a blade should be less than the width and length of the blade. The broad flat surface of a blade is a blade section having the largest area among all sections of the blade. In a vehicle provided by the present invention, a blade is usually connected with a blade sleeve through a blade handle. If a blade and a blade sleeve are directly connected to the same blade handle, the connected blade, blade handle and blade sleeve are together called a blade unit in this invention. A blade unit can be perpendicular to its main shaft or not, but below we will only use the case where the blade unit is perpendicular to its main shaft as an example to describe the working principles of the present invention. A plane containing the longitudinal axis of a blade handle of a blade unit and perpendicular to the main shaft carrying the blade unit is called a blade rotation plane, a plane that the blade unit rotates in or along it or in other words, a plane formed by rotating the longitudinal axis of the blade handle of a blade unit when the blade unit rotates along with its main shaft. A plane containing both the longitudinal axis of a blade handle of a blade unit and the longitudinal axis of its main shaft (i.e. the central line of the main shaft) is called the opening plane of the blade unit or the opening plane of the blade of the blade unit. The meeting place of a blade rotation plane and the main shaft carrying the blade unit is the place where the blade sleeve of the blade unit is fixed on the main shaft. Each main shaft can have just one blade rotation plane, or two or more than two blade rotation planes. Each blade rotation plane can have just one blade unit, or two or more than two blade units. In this invention, when the broad flat surface of a blade of a blade unit is located in or close to be located in the blade rotation plane of the blade unit, the blade is called to be “closed”, “fully closed” or “in a closed status”. When the broad flat surface of a blade of a blade unit is perpendicular or close to be perpendicular to the blade rotation plane of the blade unit (i.e. located in or close to be located in the opening plane of the blade), the blade is called to be “open”, “opened”, “fully opened”, “fully open” or “in an opened status”.

In a vehicle provided by the present invention, the blade units on the same main shaft can be installed in any possible relative positions, but the present invention also further provides a special way, called “blade-combination” technique, to arrange the blade units. The main characteristic of the blade-combination technique is that when on one main shaft there are two or more blade units all located in an opening plane of a blade, the blades of these blade units should open together at the same time to make the adjacent edges of the two blades next to each other overlap or seal with each other or close to seal with each other (with a distance of less than 10% of the blade width). All the blades when opened located in the same opening plane of a blade, carried by the same main shaft and having the above described relationships are together called “a set of combined blades” in this invention.

With the help of the above blade-combination technique, several narrow blades can be used to replace a wide blade and at the same time keep the opening area for attacking air the same. For the same attacking area, several narrow blades are easier to spin to get open or closed than a wide blade. Moreover, when closed, the several narrow blades in a set of combined blades will hide each other if viewed from a side of the vehicle and only the broad flat surface of the blade furthest from the fuselage can be viewed if all the narrow blades have the same size and shape, thus having a smaller side-view area to expose than the corresponding wide blade. Therefore, when there is a side-way wind during flying, a set of combined blades can greatly reduce the vehicle's interaction with side-way wind, making flying easier to control. On the other hand, in comparison to blades that are on the same main shaft and open at the same time but do not combine with each other (i.e. the edges of adjacent blades do not overlap or seal with each other, but instead, have a big gap between each other) (called a set of separated blades), one important advantage of a set of combined blades is that when the two sets have the same number of blades and the blades are also all identical between the two sets, a set of combined blades can attack air in a stronger way, thus improving the production of lift and forward thrust with the same total blade surface area. Similarly, with the same total blade surface area, since a set of combined blades can have more interaction with surrounding air than a set of not combined blades, a set of combined blades is also better for gliding.

Though blade-combination technique has the above advantages, a vehicle provided by the present invention can also use any other design to arrange its blade units.

### Blade Open-Close Devices:

Whether using combined blades or separated blades, the crucial point for a vehicle provided by the present invention is how to make each blade to open and close precisely at suitable positions in every cycle it rotates along with its main shaft (public rotation). The equipment that controls blades to open and close is called the blade open-close device in the present invention. To embody the present invention, several kinds of blade open-close device are described as follows. However, a vehicle provided by the present invention can also use any other type of device as a blade open-close device.

1. A Gear-Typed Blade Open-Close Device:

A blade open-close device should better, at every rotation cycle, be able to precisely open blades at which blade angle, to make the blades get fully opened after rotating what degrees of blade angle, and then to close the blades at which blade angle and to make the blades get fully closed after rotating what degrees of blade angle. Among all the designs, a gear-typed structure may be the most straight-forward design.

In a gear-typed blade open-close device, two ring segment-shaped plates located in a vertical plane perpendicular to a main shaft that carries blades are installed on the fuselage and use the main shaft as their circle center. On a surface of each of the two ring segment-shaped plates, there are radial teeth spreading over an arc region with a central angle of less than 90°. There is a gear fixed on the blade handle of each blade. The gears on the blade handles can be directly in mesh with and thus be driven by the teeth on the ring segment-shaped plates. Alternatively, an additional gear can be installed on the main shaft and be controlled by the teeth on the ring segment-shaped plates. The gears on blade handles can then be connected with this additional gear (or another gear that has the same axle as and can rotate with “this additional gear” synchronously) through a chain-like structure and then be controlled indirectly by the ring segment-shaped teeth plates. To make the description easy, in this invention, the gear that is on a main shaft and can be directly in mesh with the teeth on the ring segment-shaped plates is called a controlled gear. The above ring segment-shaped teeth plates installed on the fuselage are called controlling gears. The gear on a blade handle can be a controlled gear or alternatively, is connected through a chain-like structure with a controlled gear (or a gear that is fixed on the same axle as and rotates synchronously with a controlled gear).

When rotating with its main shaft, a blade in a blade unit can be controlled directly or indirectly (through a chain-like structure) by the two controlling gears to open or close. No matter how many blades on a main shaft, usually only two controlling gears are required for each main shaft.

The working principle of such a gear-typed blade open-close device can be described briefly as follows. When a blade unit with a so far closed blade rotates along with its main shaft (public rotation) to the first controlling gear, a controlled gear will be in mesh with and driven by the first controlling gear, causing blade handles that are connected and the blade of the blade unit to spin. If the controlled gear is fixed on another handle, it will, through a gear fixed on the blade handle of the blade unit and connected with the controlled gear through a chain-like structure, bring the blade handle and the blade of the blade unit to spin. After the controlled gear rotates and passes the first controlling gear, it is disengaged from the first controlling gear and then, together with the blade handle of the blade unit, stops spinning. By then, the blade handle and also the blade should have both spun 90° around their own axis, making the blade become fully open. The opened blade will attack surrounding air with its broad flat surface (which has a large area) as it rotates with the main shaft, thus producing a desired thrust for the vehicle (it is usually a lift and/or a forward thrust, but can also be a downward and/or backward thrust if needed). After the blade rotates a certain degree of angle, it reaches the location of the second controlling gear. The second controlling gear will be in mesh with and drive the controlled gear, which further brings the blade handle and the blade to spin another 90°, making the blade become fully closed. The closed blade rotates through air with a smaller area facing air, thus passing through air with a small resistance, until it reaches the first controlling gear again.

To make the blade spin exactly 90° each time after it passes a controlling gear, it is necessary to keep the ratio of the teeth number (Sjb) of the gear fixed on the blade handle and the teeth number (Skz) of each of the controlling gears as follows: Skz=¼ Sjb. In other words, the teeth number of each of the controlling gears is one fourth of that of the corresponding gear on the blade handle of the blade.

Besides making blades spin 90° each time after they pass a controlling gear to make them change from fully closed to fully opened or from fully opened to fully closed, it is also desirable to be able to turn the controlling gears around the main shaft to adjust the location and central angle size of the open region of the blade, thus allowing the vehicle to choose the direction and magnitude of the thrust obtained from air under an optimal energy efficiency. In the present invention, the device that can adjust the location and the central angle size of the open region of a blade(s) is called a blade open-region adjuster, which can be regarded as a part of a blade open-close device. There can be many kinds of design for a blade open-region adjuster. In the present invention only two types are described, as follows. One is called a remote-controlled type and the other a gear-controlled type. A vehicle provided by this invention can also use any other type of blade open-region adjusters.

In a remote-controlled type of blade open-region adjuster, the back-and-forth movement of the controlling gears on a circle track using the main shaft as the circle center is controlled remotely. The controlling gears, each equipped with a small electric motor (like that used in some remote-controlled toy cars) which is double-direction rotatable and under the control of a remote control, can be installed, through bearings, bearing balls or other low friction structure(s), on a circular track with the main shaft as the circle center. By controlling the rotation speed and direction of the small electric motor with a remote control, the controlling gears equipped with the electric motors can move backward or forward along the track and reach any desired location. When there are two controlling gears corresponding to one main shaft, the open region of the blade(s) can be easily set by moving the two controlling gears separately or coordinately.

As for a gear-controlled type of blade open-region adjuster, to make the operation easy, the two controlling gears can be fixed in relative to each other, causing the central angle size of the blade open region fixed. In this way, the adjustment of the amount of the thrust gained from air is mainly made by adjusting the rotation speed of the main shaft and the adjustment of the direction of the thrust is through adjusting the location of the blade open area. In such a design, the two controlling gears can be fixed on a vertical ring, which uses the main shaft as the center and installed on one side of the fuselage through bearings, bearing balls or other low friction structures so that it can rotate around the main shaft in a low friction. A gear (called phase gear) is fixed on the inner side (the controlling gears are fixed on the outer side) of the ring and also uses main shaft as the center and is directly in mesh with another gear (called driving gear). The driving gear is connected with a rotation handle, directly or through a chain-like structure. Manually rotating the rotation handle can rotate the driving gear, which further drives the phase gear to rotate and makes it reach a desired position. To make the controlling gears stay at the desired position till the next adjustment, a key for anti-free rotation can be added onto the rotation handle. Insertion of the anti-free rotation key can lock the rotation handle and pullout of the key allows the handle to be rotated.

In the above gear-controlled type of blade open-region adjuster, if the movement of the two controlling gears relative to each other is desired, the two controlling gears should be separately fixed on two rings with different radius but using the same main shaft as the center. The two controlling gears can still have the same distance to the main shaft, but in this case one controlling gear needs to be fixed on the outer edge of a ring and the other on the inner edge of another ring. Each ring has a phase gear fixed on its inner side and in mesh with a driving gear, which is further under the control of a rotation handle. By rotating the two rotation handles, each for a different ring, separately the blade open region (i.e. the position of each controlling gear) can be set to any desired size and location. Alternatively, the two controlling gears can have different radius by being fixed directly on the surface of the two rings with different radius. Accordingly, the controlled gear is replaced with two controlled gears, one having the same distance to the main shaft as one of the controlling gears and also in mesh with it, and the other having the same distance to the main shaft as the other controlling gear and in mesh with it. The two controlled gears are fixed on the same handle. Alternatively, the two controlled gears can be replaced by a controlled gear long enough to be in mesh with both of the controlling gears.

Instead of using a rotation handle to rotate a driving gear by hand, an electric motor can also be used to drive the driving gear, which further transfers the rotation to a phase gear and thus set the location of a controlling gear. The electric motor can be controlled through a revolving button on a control panel, or through a remote control. Moreover, the two controlling gears can be installed on the same ring and the location of the blade open region can be adjusted by rotating this ring. At the same time the two controlling gears can also move relative to each other along the ring and the size of the blade open region can be adjusted by moving the two controlling gears relative to each other. Similar to the above remote-controlled type of blade open-region adjuster, an electric motor can be installed on one or each of the controlling gears to drive the controlling gear(s) to move relative to each other along the ring. The rotation of the ring can also be driven by an electric motor. If the electric motor on the ring and that on a controlling gear are all controlled by remote controls, this adjuster will have two remote controls (in practice they can be combined into one), which is similar to the above remote-controlled type of blade open-region adjuster. However, this adjuster may be easier to operate. Controlling the movement of the electric motor installed on the ring through a remote control can adjust the location of the blade open region and this can be regarded as an approximate adjustment, while controlling the movement of the electric motor fixed on one or each of the controlling gears can adjust the size of the blade open region and this can be regarded as a fine adjustment, thus making the whole adjustment easy to understand and operate.

In another kind of blade open-region adjuster, only one controlling gear is used and it is to control the opening of the blades, while the closing of the blades is made passively by air and no controlling gear is used for it. The passive closing of the blades by air can be achieved simply by releasing the blade anti-free rotation device (its achievement can be seen in the following part named “blade anti-free rotation device”). The method that uses air to close the blade(s) is called a free-styled blade closing method. When there is no wind or when the wind blows in a direction the same as or opposite to that the vehicle moves toward, the free-styled blade closing method can really close the blade(s), which means the broad flat surfaces of blades locate in the blade rotation planes. When the direction of the wind is not parallel to the flying direction of the vehicle, the broad flat surface of the blade closed by air will not locate in the blade rotation plane. Instead, it will be closed along the direction of the air speed relative to the blade. One of the advantages of the free-styled blade closing method is that it can minimize the resistance of air to a closed blade and maximize the area with which a blade attacks the air, after the blade gets open by spinning 90° from the closed status. One of the disadvantages of this method is that when the broad flat surfaces of closed blades are quite not in the blade rotation plane, it will be difficult to form a set of combined blades.

All the blade open-region adjusters and the free-styled blade closing method described above can be also used, directly or with slight modification, in all the blade open-close devices described as follows.

2. An Eccentric Bar-Typed Blade Open-Close Device:

In an eccentric bar-typed blade open-close device, on a main shaft there is a gear fixed directly on a blade handle or connected to a gear on a blade handle through a chain-like structure. On this gear at an eccentric spot there is rotatable pushing bar installed, while the other end of the bar pointing toward a plane on which there is a raised ring segment using the main shaft as its circle center and fixed on one side of the fuselage. When the pushing bar rotates along with the main shaft to the place of the raised ring segment, one end of the pushing bar is pushed by the raised ring segment. The being pushed pushing bar moves to push the gear (controlled gear) which is connected with the other end of the bar at an eccentric point to rotate and the rotating gear further brings the blade handle and the blade fixed on the handle to spin, making the blade open. To retrieve the pushing bar (to close the blade), a retrieving spring can be used. Alternatively, the pushing bar can also be retrieved by the interaction between the blade and air, instead of a spring.

The pushing bar can be installed on the main shaft through a groove-shaped or ring-shaped structure in a way that makes the bar and its movement both parallel to the main shaft. In this way, when being pushed by the raised ring segment, the pushing bar can directly pushes the gear connected with it to rotate. Alternatively, the bar can be installed on the main shaft through a fixing point in a way that allows the bar to rotate around the point. In this way, when one end of the pushing bar is pushed by the raised ring segment, the pushing bar will rotate around the fixing point and cause the other end to rotate, which brings the gear that connects with the “other end” of the pushing bar to rotate, resulting in blade handles and blades to spin to make blades open.

The working process of the eccentric bar-typed blade open-close device can be briefly described as follows. When the pushing bar carried by a main shaft rotates to the location of the raised ring segment, an end of the bar is pushed by the raised ring segment, causing the other end of the pushing bar to move, which further brings the gear connected with the pushing bar to rotate. The rotating gear further directly or through a chain-like structure brings blade handles and blades to spin, making blades open. The opened blades rotate along with the main shaft carrying the blades to attack air to gain a desired thrust. After passing through the raised ring segment, under the force from a retrieving spring or from the interaction of air with blades, the pushing bar returns to its starting position and blades become closed again. The rotating main shaft then carries the closed blade to cut through the air under a small resistance until it reaches the position of the raised ring segment again.

A small rolling wheel or rolling ball can be installed on the pushing bar at the end that touches the raised ring segment so that the friction that the pushing bar receives when skidding on the raised ring segment can be reduced.

In this eccentric bar-typed blade open-close device, the position of the raised ring segment can be adjusted by any of the blade open-region adjusters described above in the “gear-typed blade open-close device” or any other kind of blade open-region adjuster. The raised ring segment can also be consisted of two small raised ring segments, wherein one of the small ring segments can insert into the other so that the whole length of the raised ring segment and thus the angle size of the blade open region can be adjusted.

3. A Conductive Track-Typed Blade Open-Close Device:

In a conductive track-typed blade open-close device, a small electric motor is fixed on a main shaft. The shaft of the electric motor is connected with blade handles through a belt-like or chain-like structure, so that the electric motor can drive the spin of the blade handles and the blades. The electric motor carries its own battery to use or uses any other battery on the vehicle. The circuit of the electric motor is disconnected, unless the two ends of one of the two or more parallel switches in this circuit both at the same time touches a ring segment-shaped conductor (called a conductive track in the present invention), which is fixed on one side of the fuselage and using the main shaft as its circle center. The two or more parallel switches are fixed on a blade handle or another rotary handle that is connected with blade handles through a chain-like structure so that they can rotate together. Either the blade handle that is fixed on the main shaft and carries the parallel switches or the rotary handle that is fixed on the main shaft and carries the parallel switches is called a switch handle in the present invention. When a switch handle spins synchronously (i.e. spinning at the same time and with the same angular velocity) with blade handles that it is connected with, four parallel switches can be installed on the switch handle. We will use such a case as an example to describe the structure and working principle of the conductive track-typed blade open-close device. In this case, the two ends of each switch are a pair of conductive ring segments encircling the switch handle and each having a central angular size of 90° (or a little over 90°). The two ends of each switch align up and down with each other along the switch handle to form a switch. The two switches next to each other at left or right are installed at different heights if measured from the main shaft and have a 90° angular distance between each other. The two switches facing each other across the switch handle are installed at the same height if measured from the main shaft. There are two conductive tracks for a main shaft, both using the main shaft as their circle center but having different radius. The two switches facing each other (having an angular distance of 180°) locates at the same height as one of the conductive tracks if measured from the main shaft, while the other two switches facing each other locates at the same height as the other conductive track. In this arrangement, when a switch is facing its corresponding conductive track, it can contact the conductive track and make the circuit of the electric motor get connected and the electric motor start to rotate to bring the blade handles and the blades to spin.

The working principle of the above conductive track-typed blade open-close device can be briefly described as follows. When the blades are closed, when the switch handle rotates along with the main shaft to the place where a conductive track is located, the two ends of a switch which has the same radius (relative to the main shaft) as this conductive track, start to contact this conductive track, making the circuit of the electric motor get connected and the electric motor start to rotate. The rotating electric motor drives the switch handle and the blade handles connected with the switch handle to spin, causing the blades to open from a closed status. After the blade handles spin 90°, the blades get fully opened and the two ends of the switch have also turned 90° and do not face and contact the conductive track any more, causing the circuit of electric motor to get disconnected, the motor to stop rotating and the blades to stay fully opened to attack the air. At this moment the next switch located at a height different from the first switch starts to face the plane where the conductive tracks are located. When the switch handle continues to rotate along with the main shaft and reaches the place where the second conductive track is located, the two ends of this switch start to contact the second conductive track, making the circuit of the electric motor get connected and the electric motor start to rotate to drive the blades to spin to get closed. After turning 90°, the blade gets fully closed and the two ends of the above second switch have also turned 90° and do not contact the conductive track any more, causing the circuit of electric motor to get disconnected, the motor to stop rotating and the blade to stay fully closed to cut through the air. Then a switch located at a different height starts to face the plane where the conductive tracks are located. When the switch handle rotates along with the main shaft to the place where the first conductive track is located, the circuit of the electric motor will get connected again and the above process gets repeated.

When the angular speed (Zkg) of the switch handle is different from that (Zjb) of the blade handles which it connects with, the central angular length of the two ends of each switch will not be 90°, but 90°*(Zkg/Zjb). In this case, there can be two or more switches on a switch handle.

If the switches of different height are installed in a way that makes the electric motor rotate at opposite directions, just two switches will be enough for each switch handle if the switch handle is rotating synchronously with the blade handle it connects with. In this case, one direction rotation of the motor makes the blade open, while the opposite direction rotation of the motor makes the blade close. Moreover, if it is designed that every next contact with the conductive tracks can make the motor rotate in an opposite direction, one switch will be even enough for each switch handle. For this purpose, the two conductive tracks should have the same distance to the main shaft and the front end (the end that is contacted by the switch first at each time) of each track should be slightly thicker (i.e. higher above the track base) than other parts of the track. In this way, after the contact of the switch with a conductive track has made a blade handle turn 90°, the two ends of the switch will be out of touch with the rear end of the conductive track, causing the circuit of the electric motor to be disconnected. When the two ends of the switch rotating along with the main shaft reach the location of the next conductive track, they can still contact the front end (since it is thicker or higher) of the second track and cause the motor to rotate in a direction opposite to the last rotation. After the blade finishes another 90° spin, the switch will be out of contact with the track again and the rotation of the electric motor stops until the switch rotates along with the main shaft to the location of the first conductive track, and so on.

Moreover, slightly different from the above method, in which the two ends of a switch contact the conductive track at the same time to connect the circuit of the electric motor, another design can also be used. In this design, one end of a switch is or is always connected with the two conductive tracks on the fuselage and the other end of the switch is a conductive ring segment fixed on the switch handle, similar to the ring segment in the above-described switch. With a working principle similar to that of the above design, this design can also correctly control the open and close of the blade(s).

The above electric motor can also be replaced with an electromagnet(s) or a combination of electromagnet and spring. When an electromagnet(s) is used to replace the electric motor, two conductive tracks and two switches will be used in a conductive track-typed blade open-close device. There can many designs to achieve this. In one of them, for example, a wheel (or a bar) is fixed on a blade handle or a handle that is connected with the blade handle through a chain or chain-like structure, and a magnet is fixed on the edge (or an end) or close to the edge (or an end) of the wheel (or the bar). At each pole of the magnet (at just one pole also works), there is an electromagnet under the control of the two parallel switches. When one of the switches faces and contacts the track designed to open the blade and also to keep the blade open (the blade-open track), the electromagnets will be supplied an electric current in a direction that makes the electromagnets produce magnetic fields of the same direction and thus both push or pull the magnet fixed on the blade handle to move in the same direction toward one of the two electromagnets and to reach a designed position. The moving magnet rotates the blade handle carrying the fixed wheel or bar and causes the blades to open and stay open until this switch passes this blade-open conductive track. Right after this switch passes this blade-open conductive track, another switch will face and contact the other conductive track, causing an electric current reverse in the electromagnets and making the magnet move in a direction opposite to its last movement and then stop at another designed position. At the same time the blade handle and its blade are driven to spin to get closed and then to stay closed until this second switch passes the second track. In this case, the blade-open track functions like the raised ring segment in the eccentric bar-typed blade open-close device described above: its length (or angular size) and its position determine the size and the position of the blade-open region, respectively. Similarly, the blade-close track determines the size and position of the blade-close region.

When a combination of electromagnets and springs is used, the device can just use one conductive track and one switch. There can be many designs to achieve this. In one of them, for example, a wheel (or a bar) is fixed on a blade handle or a handle that is connected with the blade handle through a chain or chain-like structure and a magnet is fixed on the edge (or an end) or close to the edge (or an end) of the wheel (or bar). A spring fixed on the main shaft or the blade sleeve (or the sleeve of a rotary handle) is attached to and pull the wheel (or the bar) or the magnet on the wheel (or the bar) to rotate toward the spring, causing the blade handle to rotate at the same time. An electromagnet under the control of a switch described in the above conductive track-typed open-close device can attract the magnet to rotate toward an opposite direction, if the circuit of the electromagnet is connected. When the switch is not touching the conductive track, the electromagnet is disconnected from its power supply (battery), the wheel (or bar) stays at a designed position due to the pulling force of the spring and in this period the blade is fully closed. After the switch contacts the conductive track, the electromagnet is connected to its power supply and produces magnetic field to attract the magnet to make it overcome the spring's pulling force and move to another designed position and stay. The movement of the magnet causes the wheel or bar to move, making the blade handle or rotary handle to spin to make blades get fully opened. The blades will stay open until the switch passes the track. After the switch passes the conductive track, the electromagnet is disconnected and the magnet returns to the first designed position under the force of the spring. At the same time, the blade gets fully closed. In this case, the conductive track functions like the raised ring segment in the eccentric bar-typed blade open-close device described above: its length (or angular size) and its position determine the size and the position of the blade-open region, respectively.

In all the conductive track-typed blade open-close devices as described above, the locations of the blade to open and to close, which are also the locations of the conductive tracks, can be adjusted by any of the blade open-region adjusters described above in the “gear-typed blade open-close device” or any other kind of blade open-region adjusters.

4. A Switch-Typed Blade Open-Close Device:

A switch-typed blade open-close device has a structure and a working principle both similar to that of the “conductive track-typed blade open-close device” as described above. The major difference is that it uses pushing/pressing switches, instead of conductive tracks, to connect or disconnect the circuit.

Similar to the conductive track-typed blade open-close device, a switch-typed blade open-close device also has a small electric motor fixed on a main shaft of the vehicle. The shaft of the electric motor is connected with blade handles through a belt-like or chain-like structure, so that the electric motor can drive the spin of the blade handles and the blades.

The connection or disconnection of the circuit of the electric motor is controlled by a switch(s) fixed on a blade handle or a rotary handle which is connected through a chain-like structure and thus rotates with a blade handles (similar to the above, the handle that carries the switches is called a switch handle). To describe the structure and the working principle of a switch-typed blade open-close device, an example is used, in which the blade handles and the switch handle rotate synchronously (rotate at the same time and with the same angular speed). In this case, there are eight switch buttons fixed on a switch handle. Four of them are located at the same height (i.e. at the same radius if using the main shaft as the circle center) on the handle and surround the axis of the handle in a 90° central angular distance between buttons next to each other. The other four switch buttons are located at another height and also have a 90° angular distance between buttons next to each other. The switch buttons at different height are aligned in pairs vertically (or almost vertically) along the switch handle. All these switch buttons can press the same continual switch. A continual switch is a switch that can turn on and off continually when being pressed continually. In other words, if one press makes it turn on, the next press makes it turn off, and so on. Such a continual switch is easy to make, for example, using a gear structure and can be commercially available. There are two pressing ring segments installed on one side of the fuselage, both using the main shaft as their circle center but having different radius. The radii of the pressing ring segments equal the distances of the switch buttons to the axis of the main shaft, respectively. When a switch button facing the pressing segments rotates to the position of the pressing ring segment that has the same radius (using the main shaft as the center), it will be pressed by the pressing ring segment. In the present invention, the pressing ring segment located at the place to make the blade open is called opening segment, while the pressing ring segment located at the place to make the blade close is called closing segment. The switch buttons having the same distance to the main shaft as the opening segment is called opening buttons, while the switch buttons having the same distance to the main shaft as the closing segment is called closing buttons. A closing button is always aligned in a straight (or very close to) up-and-down manner with an opening button along the switch handle.

The working principle of the above switch-typed blade open-close device can be briefly described as follows. When the blades are closed and the electric motor is not rotating due to the disconnection of the circuit, there is a pair of up-and-down aligned switch buttons facing the plane of the pressing ring segments. When the switch handle along with the main shaft rotates to the first pressing ring segment (the opening segment), the switch button (an opening button) facing this segment and also having the same distance to the main shaft as this segment is pressed (the other button (closing button) can not be pressed and thus has no effect), causing the continual switch to turn on and the electric motor to rotate. The electric motor then drives the switch handle and the blade handles to spin, making the blades start to open. After the blade handles spin 90°, the blades become fully open. At the same time the switch handle also synchronously spins 90°, causing the next pair of up-and-down aligned switch buttons to face the plane of the pressing ring segments and the switch button (an opening button) having the same height as the opening segment to be pressed. The press to the switch button causes the continual switch to turn off and the electric motor to stop rotating, making the blades stay fully opened to attack air to gain thrust. During this period, the other switch button (closing button) that aligned up-and-down with the being pressed switch button can not be pressed since it has not yet met the pressing ring segment of the same height. When the blade handles and the switch handle along with the main shaft further rotate to the closing segment, the switch button (closing button) that has the same height as the closing segment and was not pressed last time is pressed, causing the switch to turn on and the electric motor to rotate, further causing the switch handle and the blade handles to spin to start closing the blades. After the blade handles spin 90°, the blades become fully closed. At the same time the next pair of up-and-down aligned switch buttons rotates to face the plane of pressing ring segments and the switch button (closing button) having the same height as the closing ring segment is pressed by the closing segment, causing the continual switch to turn off and the electric motor to stop rotating, making the blades stay fully closed to pass through the air, until they rotates to the opening ring segment. When the blade handles and the switch handle along with the main shaft rotate to the opening segment again, the above process starts to repeat.

When the angular speed of the switch handle is different from that of the blade handle, the angular distance of the switch buttons having the same height will not be 90°, and there can be other numbers of switch button on a switch handle.

If pressing the closing button that can turn on the continual switch causes the electric motor to rotate in a direction opposite to that the opening button causes (i.e. returning to the starting status by reverse rotation), just four switch buttons will be enough for each switch handle. In this case, one direction rotation of the motor makes the blade open, while the opposite direction rotation of the motor makes the blade close. Indeed, if it is designed that every next switch turn-on can make the motor rotate in the opposite direction, two switch buttons can even be enough. For this purpose, the two pressing ring segments should be installed to have the same distance to the main shaft they surround, and the front end of each ring segment should be slightly thicker (i.e. the front end raises slightly higher) than other parts, which all have the same thickness, of the ring segment. In this way, after the first switch button is pressed by a ring segment, the electric motor starts to rotate. After the blade handles spin 90°, the second switch button will be pressed by the rear part of this ring segment and the electric motor stops rotating. When the second switch button rotating along with the main shaft reaches the place of the next ring segment, it can still be pressed by the slightly higher front end of the second ring segment and makes the motor start to rotate in a direction opposite to the last rotation. After the blade handles finish another 90° spin, the first switch button will be pressed and the electric motor stops rotating, and so on.

The above design can also be modified in another way to give a modified design. In the modified switch-typed blade open-close device, the connection of the circuit of the electric motor is still controlled by the switch fixed on the switch handle, but the disconnection of the circuit is controlled by switches carried by the electric motor itself. If the shaft of the electric motor rotates synchronously (i.e. to start and to stop to rotate at the same time and to rotate at the same angular speed) with the blade handle, four switches surrounding the shaft of the electric motor in a 90° angular distance between switches next to each other are fixed on the body of the electric motor. A pressing bar fixed on the shaft of the electric motor can press the four switches in turn as it rotates with the shaft. The working principle of the modified design can be described as follows. The initial status can be such a moment that the pressing bar just passed a switch, the electric motor just starts to rotate and the blade just starts to spin from a fully opened or closed status. Then after the electric motor rotates 90°, the pressing bar on the shaft of the electric motor also rotates 90° and presses the next switch fixed on the motor body, causing the circuit of the electric motor to be disconnected, the electric motor to stop rotating and the blade to become fully closed from fully opened or become fully opened from fully closed. If due to teeth number difference, the shaft of the electric motor rotates in an angular speed different from that of the blade handle, the distance of switches on the electric motor body will not be 90° any more. If the teeth number of the gear on the electric motor shaft is Sdj and the teeth number of the gear fixed on the blade handle and connected with the gear on the electric motor shaft is Sjb, the distance between two switches next to each other will be 90°*(Sjb/Sdj).

Alternatively, if a stepping electric motor is used, the switches that functions to disconnect the circuit can be omitted. The step length of a stepping motor can be set as a certain angle to rotate each time. After having rotated such an angle, the electric motor will stop rotating automatically. If the electric motor and the blade handle, connected with each other directly or through a chain-like structure, rotate synchronously, the step length should be 90°. If the gear on the shaft of the electric motor is smaller than the connected gear on the blade handle, the step length can be bigger. If the teeth number of the gear on the electric motor is Sdj and the teeth number of the connected gear on the blade handle is Sjb, the step length of the electric motor should be 90°*(Sjb/Sdj).

Similar to what is described in the above “conductive track-typed blade open-close device”, the electric motor in a switch-typed blade open-close device can also be replaced by an electromagnet(s) or a combination of electromagnets and springs. In this case, the two pressing ring segments installed on the fuselage are replaced by two pushing bars, one located at the position to open the blade, the other at the position to close the blade. Therefore, the location and the size of the blade open-region are determined by the positions of the two pushing bars and their distance to each other. In accordance to the changing of pressing ring segments into pushing bars, the switch buttons on the switch handle needs to be changed into a gear or gear-shaped structure and the switch needs to be changed into a gear-controlled switch. Each push from a pushing bar fixed on the fuselage will rotate the gear by one tooth, causing the direction of the current in the electromagnet circuit to reverse once and thus the blade to totally change its status once under the force from the electromagnet(s). If a combination of electromagnets and springs are used to replace the electric motor, it is still necessary to have the direction of the current in the electromagnet circuit to reverse once after the switch receives each push from a pushing bar fixed on the fuselage, to make the blade get fully opened from fully closed or fully closed from fully opened under a combined drive of the electromagnets and springs.

In all the switch-typed blade open-close devices described above, the locations of the blade to open and to close, which are also the locations of the pressing ring segments or pushing bars installed on the fuselage, can be adjusted by any of the blade open-region adjusters described above in the “gear-typed blade open-close device” or by any other kind of blade open-region adjusters.

5. Light Sensor-Typed or Sound Sensor-Typed Blade Open-Close Device:

A light sensor-typed or sound sensor-typed blade open-close device is very similar to the above conductive track-typed blade open-close device, except that the status of the electric motor circuit is triggered to change by the receipt of light or sound, instead of by a mechanical contact. Briefly to say, each arc-shaped light or sound-inducible switch is used to replace a pair of conductive ends of each switch, and each light or sound-producing ring segment is used to replace each conductive track, thus using the receipt of light or sound, instead of mechanical touch to trigger the switch. Below we will continue to use the case where a switch handle and a blade handle rotate synchronously (rotate at the same time and with the same angular velocity) with each other as an example to describe the working principle of this design. The structure of this design can refer to that of the conductive track-typed blade open-close device described above.

In a light sensor-typed (or sound sensor-typed) blade open-close device, if the switch handle and the blade handles rotate synchronously, either four light-inducible (or sound-inducible) switches or four receiving windows of one light-inducible (or sound-inducible) switch can be installed on the switch handle. Here we use the latter as an example to describe. The circuit of the electric motor is always in a disconnected status, unless the light-inducible (or sound-inducible) switch is on. The light-inducible (or sound-inducible) switch is always off, unless one of its light-receiving (or sound-receiving) windows is receiving light (or sound). Each light (or sound) receiving window is a cylinder segment surrounding the switch handle and using the axis of the switch handle as its central line, and having a 90° central angle, which is measured in a plane perpendicular to the switch handle and the cylinder segment surface, using the axis point on the plane as the central point. Two receiving windows next to each other at left or right are installed at different heights and also have a 90° angular distance between each other. The two windows facing each other (with an 180° distance) across the switch handle are installed at the same height. Two light-producing (or sound-producing) ring segments each having a central angle size of less than 90° are installed on the fuselage. Both of the ring segments use the main shaft as their circle center and are located in a plane perpendicular to the main shaft, but have different radius (i.e. distance to the main shaft). The two light-receiving (or sound-receiving) windows facing each other (having an angular distance of 180°) across the switch handle are installed to have the same distance to the main shaft as one of the light-producing (or sound-producing) ring segments, and thus when facing this ring segment they can receive light (or sound) signals produced by this ring segment to make the switch turn on and the circuit get connected. Similarly, the other two windows facing each other across the switch handle are installed to have the same distance to the main shaft as the other ring segment, and thus when facing this ring segment they can receive its light (or sound) to make the switch turn on and to make the circuit get connected.

The working principle of a light sensor-typed (or sound sensor-typed) blade open-close device can be briefly described as follows. When the switch handle and the blades in a fully closed status rotates with the main shaft, one of the light (or sound) receiving windows is facing the plane of the light-producing (or sound-producing) ring segments installed on the fuselage. The switch handle then rotates to the location of the first light-producing (or sound-producing) ring segment, the receiving window that is facing the ring segment plane now directly faces the ring segment and starts to receive the light (or sound) produced continuously by this ring segment, thus causing the light-inducible (or sound-inducible) switch being induced and the circuit of the electric motor being connected. The electric motor starts to rotate, driving the switch handle and blade handles (connected through a chain-like structure) to spin and making the blades open gradually. After the blade handles and the blades spin 90°, the blades become fully opened, and the window that was receiving light (or sound) signals from the first ring segment does not face the ring segment plane and the first ring segment any more and thus can not receive light (or sound). The switch then turns off, the electric motor stops rotating and the blades stay in a fully opened status to attack air. At the same time, the next receiving window which is located at a different height just starts to face the ring segment plane. When under the carriage of the main shaft the switch handle rotates to the next light-producing (or sound-producing) ring segment, the second window that is facing the ring segment plane starts to receive light (or sound) produced continuously by the second ring segment, causing the switch to turn on and the electric motor to rotate. The electric motor then drives the switch handle and the blade handles to spin, making the blades to close. After a 90° spin, the blades are fully closed and the second window turns away from the ring segment plane and the second ring segment, and thus stops receiving light (or sound) signal, causing the switch to turn off, the electric motor to stop rotating and the blades to stay in a fully closed status to pass through air. At this moment, the receiving window at a different height just starts to face the ring segment plane. When under the carriage of the main shaft the switch handle rotates to the location of the first light-producing (or sound-producing) ring segment again, the receiving window will start to receive light (or sound), causing the switch to turn on and to repeat the above process.

If the rotation angular speed (Zkg) of switch handle is different from that (Zjb) of the blade handle, the angular size of each receiving window surrounding the switch handle will not be 90°, but 90°*(Zkg/Zjb). In this case, there can be two or more receiving windows fixed on the switch handle.

If every light-receiving (or sound-receiving) window has its own switch and when receiving light, the receiving windows at different height can make the electric motor rotate in opposite directions, then two receiving windows (one at upper position and one at lower position) will be enough. Indeed, if every next receipt of light (or sound) can make the motor rotate in an opposite direction, one receiving window will be even enough for a switch handle. For this purpose, the two light-producing (or sound-producing) ring segments on the fuselage are installed to have the same distance to the main shaft and the front end (the end that meets the incoming window first at each time) of each ring segment projects light (or sound) in a slightly forward-tilted direction, while other parts of each segment project light (or sound) in a direction perpendicular to the plane of the ring segments. In this way, after the blade handle has just spun 90°, the receiving window of the switch will not face the ring segment any more, causing the circuit of the electric motor to disconnect. When the receiving window carried by the switch handle rotates to the location of the next ring segment, it can starts to receive the forward-tilted light (or sound) signal projected from the front end of the second ring segment, causing the switch to be on and the motor to rotate in a direction opposite to the last rotation. After a 90° spin, the receiving window will turn away from the ring segment plane again and thus stops receiving signal from the second ring segment, causing the electric motor to stop rotating until the receiving window rotates along with the main shaft to the location of the first ring segment, and so on.

Similar to what is described in the above conductive track-typed blade open-close device, in a light sensor-typed (or sound sensor-typed) blade open-close device, an electromagnet(s) or a combination of electromagnets and springs can also be used to replace the electric motor to drive the opening and closing of the blades.

By using two receiving holes to replace every cylinder segment-shaped receiving window, the above described light sensor-typed (or sound sensor-typed) blade open-close device can be changed to work in a way similar to the above switch-typed blade open-close device. The working principle of such a modified version of the device can refer to the working principles of the switch-typed and light sensor-typed blade open-close device as described above. In this case, an electromagnet(s) or a combination of electromagnets and springs can also be used to replace the electric motor to drive the opening and closing of the blade(s).

Alternatively, the signal-producing and signal-receiving structures can also be installed in a reversed way reversed: the light-producing (or sound-producing) holes are installed on the switch handle and the light-receiving (or sound-receiving) cylinder segment-shaped windows are installed on the fuselage. Its working principle is similar to the above described.

In the present invention, “light” can be an electromagnetic wave of any frequency or electromagnetic waves of different frequencies; “sound” can be a sound wave of any frequency or sound waves of different frequencies. “Light” and “sound” can also be any instructive signal(s) carried by electromagnetic waves or sound waves, respectively, to instruct the switch to turn on or off.

In all the light sensor-typed (or sound sensor-typed) blade open-close devices described above, the locations of the blade to open and to close, which are also the locations of the light-producing (or sound-producing) ring segments, can be adjusted by any of the blade open-region adjusters described above in the “gear-typed blade open-close device” or by any other kind of blade open-region adjusters. Additionally, after the circuit of the electric motor is connected, after a 90° spin the disconnection of the circuit can be carried out by switches on the electric motor, or by setting the step length of the stepping electric motor that replaces the above common electric motor.

6. A Continuous Type of Blade Open-Close Device:

All the blade open-close devices described above can be regarded as a precise type of blade open-close devices, since they can precisely set that at which angle to start to open the blades, after how many degrees of spinning to fully open the blades, at which angle to start to close the blades and after how many degrees of spinning to fully close the blades. Besides this precise type, there is also a type of devices which has relatively low energy efficiency but a stable and smooth operation. Its characteristic is that at normal working status, when rotating along with the main shaft, at each rotation cycle (except the first cycle or the last cycle of a working period) the blades on the main shaft are always spinning, neither stop spinning nor resume spinning. Therefore, it can be called a continuous type of blade open-close device. With this type of blade open-close device, at each rotation cycle along with the main shaft, the blade will not stay fully opened or fully closed for a while. It can be achieved by many kinds of designs, but in any of these designs, at each rotation cycle of the main shaft it should make the blade fully opened once at a position (angle) where the blade can gain the most desired thrust and make the blade fully closed once at a position opposite to the fully opening position (i.e. an 180° angular distance). As an example, a gear-typed continuous blade open-close device is disclosed as follows.

A gear-typed continuous blade open-close device is very similar to the above described “gear-typed blade open-close device”, but the controlling gear, instead of being two ring segments each with radial teeth covering a region of less than 90°, is a whole ring using a main shaft as its circle center and having radial teeth covering a whole circle (360°) on its surface. The radial teeth (in radius direction, using the main shaft as a circle center) can be evenly or slightly unevenly spread over the teethed ring surface (controlling gear). If the controlled gear is spinning synchronously (rotate at the same time and with the same angular velocity) with the blade handles it connects with, making the teeth number of the controlled gear twice as much as that of the controlling gear will result in that during every rotation cycle along with the main shaft, the blade only spin half a circle (180°) in its blade sleeve and thus open and close once: from fully closed to fully opened (90°) and then from fully opened to fully closed (90°). If the controlled gear and the blade handle it connects with through a chain-like structure rotate in a different angular speed, it is required that the teeth number of the gear on the blade handle is twice as much as that of the controlling gear.

By rotating the controlling gear around the main shaft (for example, using the blade open-region adjuster described above in the “gear-typed blade open-close device”), the blade open-region and close-region can be adjusted and a desired thrust can be gained. For example, if the blades are fully closed when they are horizontal and rotates upward to hit air (thus receiving a minimal downward reaction) and fully opened when it is horizontal and rotates downward to attack air (thus receiving a maximal upward reaction), the net thrust the blade gains at each rotation cycle will be an upward thrust. Similarly, by adjusting the position for the blade to fully open, a net thrust of other directions (for example, part upward and part forward) can be gained.

Since under the control of a continuous type of blade open-close device the blades spin in an even (or close to even) speed, the open-close process of the blades can be very smooth and easy to operate, but at the same time this also causes it the disadvantage of low energy efficiency.

In practice, no matter which kind of blade open-close devices is used in a vehicle provided by the present invention, a blade open-region adjuster is not always necessary. When two or more rotating-spinning rotors (main shafts and their carrying accessories, such as blades and blade handles. etc) are used, by assigning different rotating-spinning rotor with different functions the total thrust can be adjusted without using any blade open-region adjuster. For example, if some of the rotating-spinning rotors in a vehicle only provide vertical thrust by opening their blades in a fixed open region around a horizontal plane (where the blade angle is 0° or 180°), and the other rotating-spinning rotors only provide horizontal thrust by opening their blades in a fixed open region around a vertical plane (where the blade angle is −90° or +90°), the vehicle will not need a blade open-region adjuster to adjust the thrust obtained. By adjusting the rotation speed and rotation direction of the rotating-spinning rotors providing thrust at a vertical direction, it can adjust the magnitude of the lift, change the thrust from lift to a downward thrust or change the magnitude of the downward thrust. By adjusting the rotation speed and rotation direction of the rotating-spinning rotors providing thrust at a horizontal direction, it can adjust the magnitude of forward thrust, change the thrust from forward to backward or adjust the magnitude of the backward thrust. Certainly, even in such a design assigning main shafts (together with their blades) with different functions, a blade open-region adjuster can still be used to adjust the blade open-regions of the blades on each main shaft.

Blade Anti-Free Spinning Devices:

Except using a continuous type of blade open-close device, a vehicle with most of the other types of blade open-close devices requires that the blades do not spin in the blade working region (from a position where the blades just get fully opened to a position where the blades just start to close) to keep the blades fully opened in this region, and also do not spin in the blade closed region (from a position where the blades just get fully closed to a position where the blades just start to open) to keep blades fully closed in this region. However, due to the rotation of the main shafts and/or the flying speed of the vehicle, opened blades intend to close under the resistance from the air; and closed blades may sway under the influences of their inertia and air's resistance. To make the description easier, the spinning of the blade(s) under an active guidance or control (from a blade open-close device) is called controlled spinning in the present invention and the spinning of the blade(s) happened passively or not under a designed guidance or control is called free spinning in the present invention. To prevent free spinning of the blade(s), it is sometimes necessary to include a blade anti-free spinning device(s) in a vehicle provided by the present invention. A blade anti-free spinning device is a device that can prevent the free spinning of a blade(s). There are many designs can be used for a blade anti-free spinning device. Below are some examples of the designs for the device. A vehicle provided by the present invention can also use any other blade anti-free spinning device.

First of all, an anti-free spinning key(s) can be used for this purpose. An anti-free spinning key is usually a rod-shaped or a wedge-shaped object with good hardness. One of its ends is fixed (but can rotate) or can only move back and forth, and the other end can insert into a groove-shaped or gear-shaped structure fixed on a shaft to prevent the rotation or spinning of the shaft. In the present invention, since when rotating around the main shaft the blade(s) needs to frequently spin to open (or close) and then to stop spinning to keep the blade open (or close) for a certain time, the anti-free spinning key(s) needs to frequently insert into and then pull out of the groove-shaped or gear-shaped structure on the blade handle(s) or switch handle(s). Such a repetitive movement of the anti-free spinning key can be driven by a spring(s), an electromagnet(s) or any combination of springs and electromagnets. As an example, an electromagnet-typed anti-free spinning device is briefly described as follows.

In an electromagnet-typed anti-free spinning device, the anti-free spinning key (or a part of the key) can be a magnet (for example, an NdFeB alloy magnet) installed on a main shaft in a way that it can only move along its length at one dimension. One of its ends is close to an electromagnet and the other is close and also points to an anti-free spinning gear fixed on a blade handle (or a switch handle connected with the blade handle through a chain-like structure, or the shaft of the electric motor). At one electric current direction, the electromagnet can attract the anti-free spinning key to move toward the electromagnet and away from the anti-free spinning gear fixed on the blade handle (or switch handle or electric motor shaft), causing the key to be out of touch with the gear and thus allowing the blade to spin. When the direction of the electric current is reversed, the electromagnet will reverse its poles and push the anti-free spinning key to move away from the electromagnet and toward the anti-free spinning gear, causing the key to insert into the gear and thus preventing the gear (and also the blade) from spinning.

The movement of the anti-free spinning key can also driven by a combination of a spring and an electromagnet. For example, a spring can be used to connect the anti-free spinning key to the sleeve of the blade handle (or the sleeve of the switch handle), the body of the electric motor or the main shaft. This spring can be used to drive the anti-free spinning key to move into the anti-free spinning gear and then to stay there. In this case, the magnet on the anti-free spinning key is not necessary and can be replaced by an iron object.

To make the structure simple and the operation smooth, a blade anti-free spinning device is usually combined with a blade open-close device. Therefore, different blade anti-free spinning devices are used for different blade open-close devices.

For a conductive track-typed blade open-close device, a spring and an electromagnet can be combined and used. In this case, the electromagnet and the electric motor can be controlled by the same switch. When the switch contacts a conductive track, the circuit will be connected and the electromagnet will produce a magnetic field and attract the anti-free spinning key to leave the anti-free spinning gear, allowing the electric motor to drive the blade handle and the blade to spin. After the switch turns away from the conductive track, the switch is off, the electric motor stops rotating and the blade then should stop spinning. At the same time, the electromagnet also loses its magnetic field, allowing the spring to drive the anti-free spinning key to move and insert into the anti-free spinning gear and thus preventing the blade handle from further spinning and keeping the blade stay fully opened (or closed) until the switch reaches the conductive track that triggers the closing (or opening) of the blade. For a switch-typed or a light sensor-typed (or sound sensor-typed) blade open-close device, a device similar to the above blade anti-free spinning device can be used to prevent blade free spinning. The major point is that the electromagnet is still controlled by the same switch as the electric motor does. For a gear-typed blade open-close device, a switch, similar to the switch described in the switch-typed blade open-close device, can be fixed on the handle of the controlled gear and a switch-triggering bar can be installed on each end of each controlling gear. This switch and the switch-triggering bars can then, through a process similar to the above described, co-operatively control the connection or disconnection of an electromagnet to prevent blade from free spinning.

Besides an electromagnet(s), a blade anti-free spinning device can also use a pure mechanical structure to achieve. For example, for a gear-typed blade open-close device, a protruding object can be used for blade anti-free spinning. In this case, a raised ring segment is fixed right above or below each gear teeth region on the controlling gear and has the same angle size as each teeth region. As a blade handle or switch handle rotates to the position of a raised ring segment, the raised ring segment can push a rod fixed on an anti-free spinning key to drive the anti-free spinning key to move out of an anti-free spinning gear fixed on the blade handle or switch handle, thus allowing the blade handle or switch handle to spin to open or close the blade. After the blade handle passes this raised ring segment, the anti-free spinning key will retrieve under the help of a spring and insert into the anti-free spinning gear again, preventing the fully opened or fully closed blade from undesired spinning, until the blade handle reaches the next controlling gear.

If a blade handle(s), a switch handle and an electric motor shaft are connected through a chain-like structure, any of them can be manipulated by an anti-free spinning structure to prevent the corresponding blade(s) from free spinning. Some kinds of electric motors have anti-free spinning designs within themselves to prevent themselves from free spinning after the circuit is disconnected or if there is a power failure. If the opening and closing of the blades is driven by such an electric motor (for example, in a conductive track-typed, switch-typed or light (or sound) sensor-typed blade open-close device, as described above), such an anti-free spinning electric motor will be enough for preventing the blade(s) from free spinning. Besides all the above described methods or devices, any other anti-free spinning design can also be used in the vehicle provided by the present invention.

In some cases, a blade anti-free spinning device is not necessary. If using a continuous type of blade open-close device, the vehicle provided by the present invention does not need a blade anti-free spinning device. If using an eccentric bar-type blade open-close device, the vehicle provided by the present invention can just use a recovering spring for preventing blade from free spinning. If using a free style for blade closing, the anti-free spinning of the blade in the closed region can be achieved by either simply using a spring or by utilizing an interaction from air, and thus no blade anti-free spinning device is needed for the blade closed region. When using a conductive track-typed, a switch-typed or a light (or sound) sensor-typed blade open-close device, if an electromagnet(s) or a combination of electromagnet(s) and spring(s) is used to replace the electric motor, the vehicle provided by the present invention does not need any blade anti-free spinning device.

Fuselage Anti-Rolling Devices:

If the torque from outside is zero, a system's angular momentum is conserved. From this we can see that when an aircraft is hanging still in vacuum, though its blades can not attack the air, if the blades start to rotate and the total angular momentum of the blades is not zero, the fuselage of the aircraft will start to spin or to roll in an opposite direction to make the total angular momentum of the aircraft zero. When the aircraft is in the air, every blade will receive a torque due to air resistance. When every blade gains a non-zero net thrust in every rotation cycle along with its main shaft, this net thrust will also produce a torque to the aircraft. If all the above torques are totaled not zero, they may also cause the spinning or rolling of the fuselage of the aircraft.

The spinning or rolling of the fuselage can affect the normal flying of an aircraft or even causes an aircraft to be unable to fly. For a vehicle provided by the present invention, the major problem is rolling vertically, instead of spinning horizontally, which is the problem for current helicopters to overcome. To prevent the undesired rolling and to keep a stable posture, a vehicle provided by the present invention needs a suitable design or a special equipment to overcome undesired fuselage rolling. One of the methods is to make every rotating-spinning rotor have a corresponding rotating-spinning rotor, which is symmetric to it at the aspects as location, structure, rotation and spinning along the mass center of the aircraft. In this way, since each symmetric pair of rotating-spinning rotors have their angular momentums and torques be canceled by each other, the total angular momentum and torque of all the blades will be zero and the rolling of the fuselage will not happen. Such a structure design can be seen in FIG. 4. When there are only two rotating-spinning rotors installed, they can rotate in opposite directions. When there are four rotating-spinning rotors, the front two (one at left side and one at right side) can rotate in the same direction and the rear two can rotate in a direction opposite to that of the front two. In this case, all the four rotating-spinning rotors can be exactly the same and be driven by the same engine to rotate at the same speed, but the front two (one at left side and one at right side) can rotate in the same direction (for example, clockwise) and the rear two can rotate in a direction opposite to that of the front two (for example, counter-clockwise). In this way, the undesired rolling of the fuselage will not happen.

Indeed, to prevent fuselage from rolling, each rotating-spinning rotor does not have to have a totally symmetric rotor (symmetric to each other at location, structure, rotating and spinning). As long as their angular momentum and torque have the same value but opposite directions, the fuselage rolling will not happen. For example, at each side of the fuselage, the front and rear rotating-spinning rotors can be installed at different heights. Even when they have different radii and rotation speeds, by coordinating the relationship between the radius and the rotation speed, their angular momentums and torques can still respectively have the same value but opposite directions.

Loading variation can usually cause the mass center of a vehicle to shift. A shift of the mass center to the front, the rear, the left or the right of the vehicle can cause the above fuselage counter-rolling designs to fail. To overcome such a problem, a mass center adjusting equipment can be installed to adjust the mass center of a vehicle to a desired position, especially its position along the length or width direction of the fuselage. A simple method to adjust the mass center of a vehicle is to move around one or more weights carried by the vehicle by hands or by mechanical equipment.

Besides the above methods based on rotor deployment and mass distribution, undesired fuselage rolling can also be overcome by adjusting the relative rotation speeds of the rotating-spinning rotors of different rotation directions. For example, two main engines (or main electric motors) can be used to separately drive rotating-spinning rotors of different rotation directions. The two engines can be accelerated or decelerated by the same paddle or button, but one of the engines can still be further accelerated or decelerated by another paddle or button to regulate the relative rotation speeds of the rotors with different rotation directions. In this way, by adjusting different rotor's rotation speed, the total torque can be adjusted to get balanced, thus overcoming fuselage rolling and maintaining the vehicle in a stable posture when flying.

Another method for overcoming fuselage rolling is to install a rotor similar to the tail rotor in some of the current helicopters. It can still be called a tail rotor, but different from the tail rotor in current helicopters to have a horizontal shaft, the tail rotor for the vehicle provided in the present invention has a vertical shaft to prevent the fuselage to roll forward or backward.

The fuselage rolling of a vehicle provided by the present invention can also be overcome by adjusting the location of one or more rotating-spinning rotors. A rotating-spinning rotor can be moved around on the fuselage by moving the bearing-structure (or any other structure that can connect the shaft to the fuselage and also allows the main shaft to rotate freely in it) through which it is installed on the fuselage. A simple method to achieve this is to install the to-be-adjusted main shaft(s) on a moveable frame, whose forward and backward movement can be driven by two screws installed in screw nuts fixed on the fuselage. One screw is located in front of and the other at rear of the to-be-adjusted main shaft(s). In this way, rotating the two screws around the same direction can move the main shaft(s) back or forth on the fuselage.

The rolling or spinning of the vehicle can also be overcome by adjusting the mass center of the vehicle. This can be simply achieved by moving one or more weights around on the vehicle with hands or mechanical equipment.

A combination of any two or more of the above described methods can also be used to overcome fuselage rolling or spinning. The vehicle provided by the present invention can also use any other method that can effectively overcome fuselage rolling or spinning.

Turning Devices:

As described above, using a blade open-close device the vehicle provided by the present invention can gain a net upward, downward, forward or backward thrust to ascend, descend, move forward or move backward and thus has significant advantages over the current helicopters. Besides moving upward, downward, forward and backward, the vehicle provided by the present invention also need to be able to make turns. Therefore, it also needs a turning mechanism or device to install on it.

One of the methods for the vehicle provided by the present invention to turn is to make the blade open regions of left side rotating-spinning rotors and right side rotating-spinning rotors be controlled separately or coordinately, or to make the rotation speed or blade open region of at least one of the rotating-spinning rotors be adjusted independently or adjusted coordinately with other rotating-spinning rotors. In such a design, when the vehicle wants to turn toward one side, it just needs to slow down the rotation speed of one or more of the rotating-spinning rotors providing forward thrust and located at this side to make the forward thrust provided by this side reduced, or alternatively, to increase the rotation speed of one or more of the rotating-spinning rotors providing forward thrust and located at the other side to make the forward thrust provided by the other side increased. To make one or more rotating-spinning rotors at one side of the fuselage have a rotation speed higher or lower than that of the rotating-spinning rotors at the other side of the fuselage, a braking device (to brake main shaft (s)) can be installed on one or more rotating-spinning rotors at each side. Applying brake to one or more rotating-spinning rotors at one side of the fuselage can make the vehicle turn toward this side, and applying brake to one or more rotating-spinning rotors at the other side of the fuselage can make the vehicle turn toward “the other side”. Another simple method is to make the rotating-spinning rotors at left side and those at right side have independent rotary handles or rotary wheels to control their blade open-close device(s). In this way, by turning a controlling rotary handle or rotary wheel to adjust the size or location of the blade open region at one side of the fuselage, the forward thrust provided by the rotating-spinning rotors at this side can be increased or decreased and the vehicle can then make a desired turn. The blade open-close devices for the left side rotating-spinning rotors and the right side rotating-spinning rotors can also be designed to be adjusted coordinately by one rotary wheel (steering wheel). Turning the steering wheel can cause the left side rotating-spinning rotors' blade open region and the right side rotating-spinning rotors' blade open region change in an opposite direction, causing the forward thrust provided by the left side rotating-spinning rotors to increase or decrease and that by the right side rotating-spinning rotors to decrease or increase, respectively, and thus allowing the vehicle to make a turn.

A tail rotor same as or similar to the tail rotor used in current helicopters can also be used to allow a vehicle provided by the present invention to make turns. Such a tail rotor is installed on the tail area of a vehicle in a way that the rotation plane of its rotary blade faces toward one side of the fuselage. In a current helicopter, a tail rotor is mainly used to prevent the helicopter from undesired spinning. In a vehicle provided by the present invention, a tail rotor can be used to make turns. When rotating in the air the tail rotor can receive a pushing force, which is a horizontal force perpendicular to the longitudinal axis of the fuselage and can push the vehicle to turn to one side. By reversing the rotation direction of the tail rotor, the tail of the vehicle will receive a pushing force in an opposite direction, causing the vehicle to turn toward the other direction. The technique for a tail rotor is well known in current helicopters and can be very easily used on the vehicle provided by the present invention.

Another method for making a vehicle provided by the present invention to make turns is to install a resistant plate at each side of the vehicle. A resistant plate is a piece of thin and broad object that can stretch out from one side of the fuselage. When the vehicle does not need to make a turn, the resistant plate can keep horizontal and fly with the vehicle with a small air resistance. When the vehicle needs to turn toward one side, the resistant plate installed on this side can be rotated to become unparallel to a horizontal plane by a rotary handle connected to the shaft of the resistant plate through a chain-like or belt-like structure, causing the resistant plate to receive a bigger air resistance. This increased air resistance can produce a torque and make the vehicle turn toward this side. By rotating the resistant plate installed on the other side of the fuselage to receive an increased air resistance, the vehicle can turn toward “the other side”. When the vehicle does not need to make a turn, the resistant plates can help the vehicle to glide. When not used, the resistant plates can also be taken into the inside of the fuselage or onto the sides of the fuselage. In this case, stretching out a resistant plate from one side of the fuselage can make the vehicle turn toward this side.

The above methods or designs show that making turns is easy for the vehicle provided by the present invention. A vehicle provided by the present invention can also use any other effective design or equipment to make turns.

The principles and designs described above in the present invention provide a new type of propulsion technologies and devices, which can gain a desired thrust by controlling each blade rotating in air to open only in a angle region where it can produce a desired thrust but to close in all the other angle regions. This new technologies and devices which can gain thrust by interacting with surrounding medium can also be used for media other than air, such as water. Therefore, this new technology can also be used to design and make a new boat or ship of high energy efficiency.

Similar to current helicopters, current boats such as big-sized cargo ships, passenger ships or submarines driven by a mechanical method, mostly use screw propellers to provide thrust. Since water can provide sufficient buoyancy, a boat usually only needs thrust in a horizontal direction and thus the main shaft of its screw propeller is usually installed horizontally along and parallel to the longitudinal axis of the fuselage. In contrast, in a new boat provided by the present invention and based on the above described principles and designs, the main shaft(s) of the rotating-spinning rotor(s) is installed horizontally and perpendicular to the longitudinal axis of the fuselage.

The new boat provided by the present invention is consisted of at least a fuselage, a main engine, a power control and transmission system, a rotating-spinning rotor(s) and a blade open-close device(s). The fuselage, the engine and the power control and transmission can all be designed and made based on those used in current boats, while the rotating-spinning rotor(s) and blade open-close device(s) can be designed and made based on those used in the above described vehicle provided by the present invention.

In the new boat provided by the present invention, the main shaft(s) is installed horizontally and perpendicular to the longitudinal axis of the fuselage, but to gain a thrust in a horizontal direction its blade open region is mostly around a vertical plane, i.e. a region around the blade angle of +90° (or −90°). When needed, the new boat can also provide an upward thrust (for example, when the boat is overloaded or having water leaking in, etc.) or a downward thrust (for example, when the boat as a submarine needs to have a quick dive to avoid attack or spy), simply by moving the blade open region toward or setting the blade open region around a horizontal direction pointing forward or backward. The blade open region can be adjusted by any blade open-region adjuster which is described above in the “gear-typed blade open-close device”, or any other blade open-region adjuster.

The major characteristic of the new vehicles provided in the present invention, whether traveling in air or in water, is that they all use a new type of propulsion technologies and devices to interact with surrounding medium to gain thrust. By installing the above new air vehicle or water vehicle onto a land vehicle, or by utilizing all or part of the above new propulsion technologies and devices to a current land vehicle, or by utilizing all or part of the above new propulsion technologies and devices to modify a current land vehicle, a new vehicle capable of travelling in air and land, water and land, air and water, or water, air and land is provided. When travelling in air or in water, the new vehicle capable of traveling in air, water and/or land can use the principles, designs, technologies and/or devices of the new air vehicle or water vehicle described above to gain thrust from air or water to fly or navigate.

### BRIEF DESCRIPTION OF THE DRAWINGS

FIG. 1 is a diagram showing the force that a rotating blade obtains by attacking the air.

FIG. 2 is a top view of the overall structure of the vehicle according to the present invention.

FIG. 3 is a side view of the overall structure of the vehicle according to the present invention.

FIG. 4 to FIG. 7 are top views of the overall structure of the vehicles using four different ways for blade combination according to the present invention.

FIG. 8 is a schematic diagram showing the structure of a gear-typed blade open-close device according to the present invention.

FIG. 9 is a side view of part of the gear-typed blade open-close device of FIG. 8.

FIG. 10 is a diagram illustrating the controlling gears of FIG. 8 and FIG. 9.

FIG. 11 schematically illustrates the structure of a blade open-region adjuster according to the present invention.

FIG. 12 schematically illustrates the structure of an eccentric bar-typed blade open-close device according to the present invention.

FIG. 13 illustrates the structure of the raised ring segment in the blade open-close device of FIG. 12.

FIG. 14 illustrates the structure around the eccentric bar of FIG. 12.

FIG. 15 schematically illustrates the structure of a conductive track-typed blade open-close device according to the present invention.

FIG. 16 and FIG. 17 illustrate the structure of the switch handle of FIG. 15.

FIG. 18 schematically illustrates the structure of a switch-typed blade open-close device according to the present invention.

FIG. 19 schematically illustrates the structure of an electromagnet-typed blade anti-free spinning device according to the present invention.

FIG. 20 and FIG. 21 illustrate the insertion state and separation state of the anti-free spinning key of FIG. 19, respectively.

FIG. 22 schematically illustrates the structure of an electromagnet-spring combined blade anti-free spinning device according to the present invention.

FIG. 23 and FIG. 24 illustrate the insertion state and separation state of the anti-free spinning key of FIG. 22, respectively.

### DETAILED DESCRIPTION OF THE PREFERRED EMBODIMENTS

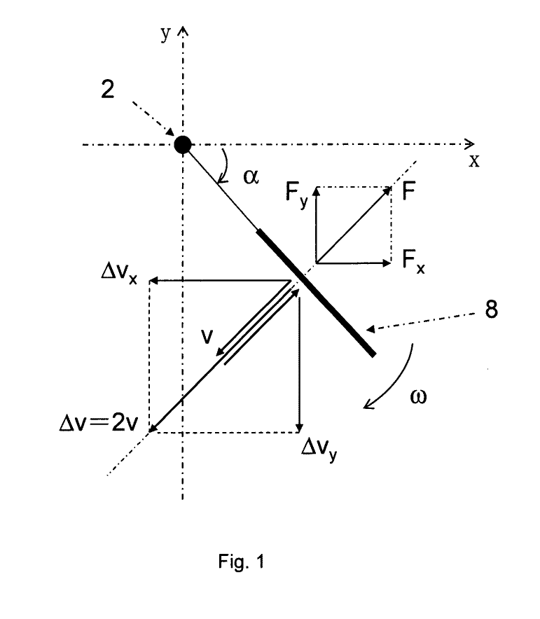

As shown in FIG. 1, suppose a vehicle provided by the present invention is flying horizontally toward right and one of its blades 8 is rotating clockwise along with a main shaft 2. In this case, if opened, the blade 8 rotating at an angular speed ω around the axis of the main shaft 2 will attack air molecules. When attacking the air at blade angle α, the blade 8 will cause each attacked air molecule to have a velocity change with a horizontal component and a vertical component, respectively, of

ΔVₓ=−2V sin α; ΔV_{y}=−2V cos α.

(Wherein, V=ωr, and r is the distance of the attacking point to the main shaft 8 and α is the blade angle where the blade 8 is.)

The blade 8 in return receives a force of reaction from the air molecules with the following horizontal component (F_{X}) and vertical component (F_{y}), respectively:

Fₓ=⅔ρhω² sin α(R₂³−R₁³)

F_{y}=⅔ρhω² cos α(R₂³−R₁³)

(Wherein, ρ is the surrounding air's density, h is the width of the blade surface, R₁ is the distance of the closer end of the blade surface to the main shaft 2 and R₂ is the distance of the further end of the blade surface to the main shaft 2.)

A positive F_{X} indicates a forward horizontal force, which is called a forward thrust in the present invention; A negative Fₓ indicates a backward horizontal force, which is called a backward thrust in the present invention. Similarly, a positive F_{y} indicates an upward vertical force, which is called a lift or an upward thrust in the present invention; A negative F_{y} indicates a downward vertical force, which is called a downward thrust in the present invention.

At the blade angle range of α=0°-90°, the vehicle can gain a forward and upward thrust from the interaction of the blade 8 with the surrounding air.

At the blade angle range of α=90°-180°, the vehicle can gain a forward and downward thrust from the interaction of the blade 8 with the surrounding air.

At the blade angle range of α=180°-270°, the vehicle can gain a backward and downward thrust from the interaction of the blade 8 with the surrounding air.

At the blade angle range of α=270°-360°, the vehicle can gain a backward and upward thrust from the interaction of the blade 8 with the surrounding air.

If at every rotation cycle around the axis of the main shaft, the blade is only open in a certain angle region in the cycle and closed in the other regions of the cycle, the blade will only receive a reaction in this region and thus gain a net thrust in every cycle. For example, if opened only at the blade angle region of 0°-90°, the blade and the vehicle can gain a forward and upward thrust. Therefore, by controlling the locations of the open region and the closed region of each blade, the new vehicle provided by the present invention can easily and quickly move up, down, forward or backward.

If at each rotation cycle the blade is opened from blade angle α₁ and then closed at blade angle α₂, the horizontal component of the average impulse which the blade receives in every rotation period (T=2π/ω) can be calculated (using ωdt=dα) and it is:

FₓT=−⅔ρhω(R₂³−R₁³)(cos α₂−cos α₁)

Then the average horizontal force that the blade receives is:

Fₓ=1/(3π)ρhω²(R₂³−R₁³)(cos α₁−cos α₂)

Fₓ can be a forward thrust (if it is positive) or a backward thrust (if it is negative). When α₂=−α₁, which means the blade open region is symmetric along a horizontal plane (for example, from −30° to)+30°, the average horizontal force will be zero and the vehicle cannot obtain a horizontal thrust. To obtain an average forward thrust, it is needed to have cos α₂<cos α₁.

Similarly, the vertical component of the average force that the blade receives is:

F_{y}=1/(3π)ρhω²(R₂³−R₁³)(sin α₂−sin α₁)

Based on the above formulas, if the blade open region is from −30° to +60°, the average upward thrust the vehicle can gain is: F_{y}=(3^{1/2}+1)/(6π)ρhω²(R₂³−R₁³); and the average forward thrust the vehicle can gain is: Fₓ=(3^{1/2}−1)/(6π)ρhω²(R₂³−R₁³).

For example, when taking off or when needing to climb, the vehicle can have its blades to keep open at the blade angle region of −30° to +45° or a smaller region within it; When needing to accelerate horizontally, the vehicle can have its blades to keep open at the blade angle region of 0° to +120° or a smaller region within it; When needing to climb vertically and accelerate horizontally, the vehicle can have its blades to keep open at the blade angle region of −30° to +120° or a smaller region within it; When needing to land or descend, the vehicle can use the gravity to descend after reducing the rotation speed of the blades, but it can also have a quicker descending by gaining an additional downward thrust, which can be gained by having its blades to keep open at the blade angle region of +90° to +270° or a smaller region within it; When needing to decelerate, brake or move backward in a horizontal direction, the vehicle can have its blades to keep open at the blade angle region of +180° to +360° or a smaller region within it; When needing to descend and brake or decelerate horizontally, the vehicle can have its blades to keep open at the blade angle region of +225° to +405° or a smaller region within it.

The flying speed of the vehicle is not considered in the above formulas, calculations and discussions. If the vehicle is flying forward horizontally (i.e. in the increasing direction of axis-x) at speed V_{f}, the horizontal and vertical components of the velocity change of an air molecule after attacked by the blade will, respectively, be:

ΔVₓ=−2V sin α+2V_{f} sin²α

ΔV_{y}=−2V cos α+V_{f} sin 2α

In this circumstance, the horizontal and vertical components of the reaction that blade receives is:

Fₓ(α)=ρhω[⅔ω(R₂³−R₁³)sin α−V_{f}(R₂²−R₁²)sin²α]

F_{y}(α)=ρhω[⅔ω(R₂³−R₁³)cos α−½V_{f}(R₂²−R₁²)sin 2α]

When the vehicle's flying speed V_{f} is far smaller than the rotational speed of any blade point located between R₁ and R₂ on the blade surface, the effect of the flying speed to the vertical thrust and horizontal thrust can be ignored, and the above calculations and discussions are still valid. However, when the vehicle's flying speed is close to the rotational speed of the points on the further end of the blade surface, for regulating the movement of the vehicle (moving up, down, forward or downward), the blade open or closed region will be different from that when the vehicle is flying in a low speed and needs to be adjusted or changed accordingly to achieve or maintain a desired flying status. For example, to keep the height of a vehicle stable, when the vehicle is motionlessly hanging over in the air it might need to have its blades to be open at the blade angle region of −30° to +30°, while when the vehicle is flying horizontally in a high speed in air, it might need to have its blades to be open at the blade angle region of −30° to +60°.

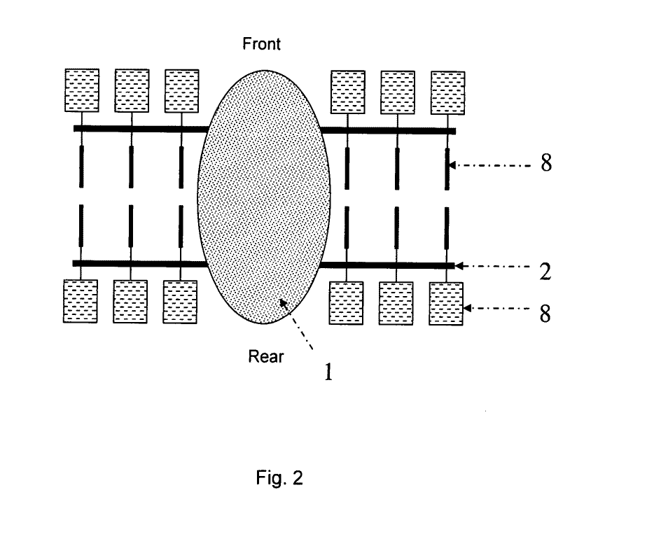

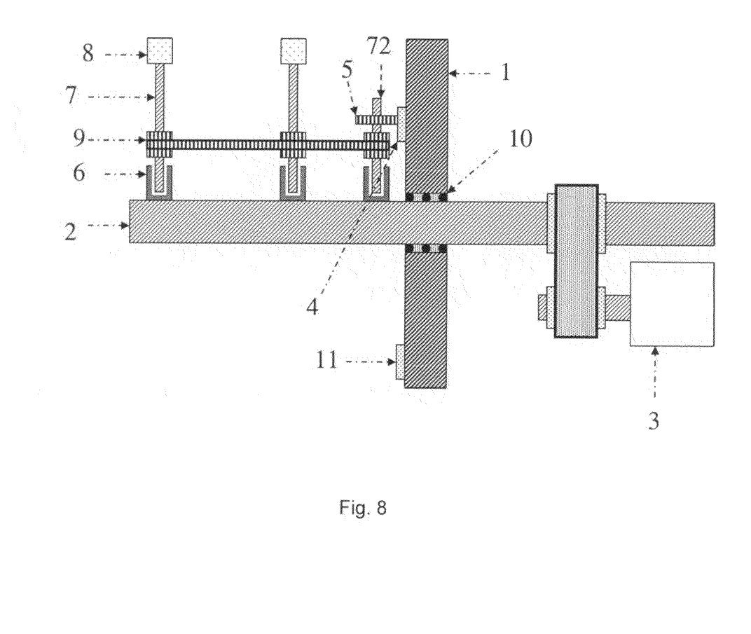

As shown in FIG. 2 to FIG. 8, the vehicle provided by the present invention includes fuselage 1, main fuel or electric engine 3 and a power control and transmission system not shown in the drawings. On the two sides of the fuselage 1, there are main shafts 2 stretching out. Blade sleeves 6 are fixed on the main shafts 2 and have blade handles 7 installed in or on it. Each blade handle 7 can spin around its own longitudinal axis not shown in the drawings and has blade 8 fixed on it. A blade open-close device partly shown in FIG. 8 is installed on the fuselage 1 to control the spinning of blade handles 7 and blades 8 relative to blade sleeves 6 and its main shaft 2. A blade open-close device is a structure that can make the blades 8 open and close once at each cycle when the blades 8 are rotating along with their main shafts 2. When opened, each blade 8 has its broad flat surface located in a plane parallel or close to parallel to its main shaft 2 and when closed, each blade 8 has its broad flat surface located in a plane perpendicular or close to perpendicular to its main shaft 2.

As shown in FIG. 2, each main shaft 2 carries six blades 8. The front pair of the main shafts 2 rotates in the same direction and their blades 8 become open when pointing toward the front and become closed when pointing toward the rear. The rear pair of the main shafts 2 rotates in the same direction, but opposite to the rotation direction of the front pair, and their blades 8 become open when pointing toward the rear and become closed when pointing toward the front.

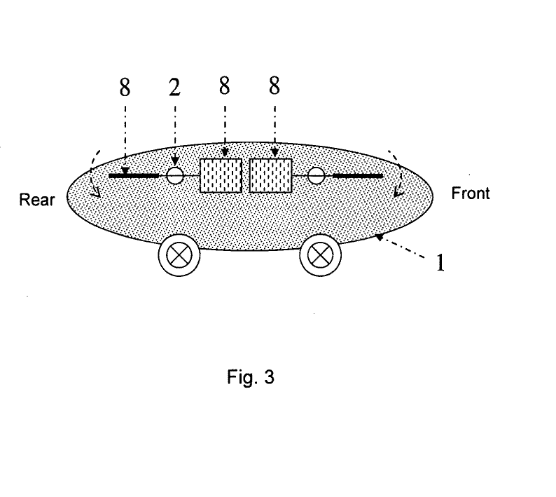

As shown in FIG. 3, the blades 8 carried by the front main shafts 2 opens when pointing toward the front and the blades 8 carried by the rear main shafts 2 opens when pointing toward the rear. At this position, being driven by their main shafts, they are rotating downward to attack the air to gain upward thrust.

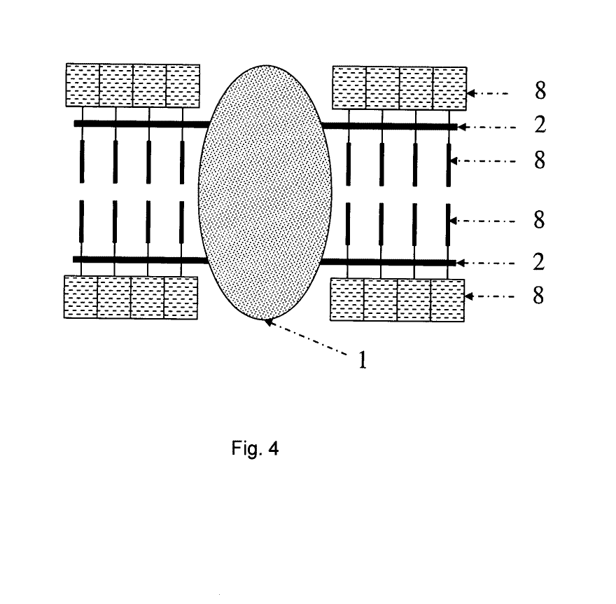

The vehicles shown in FIG. 4 to FIG. 7 all utilize the blade-combination technique.

As shown in FIG. 4, four main shafts 2 are installed on the fuselage 1 of a vehicle provided by the present invention and each of them carries eight blades 8. In this design, when being opened at the same time the blades on the same main shaft form a larger blade by joining their edges together to attack the surrounding air more efficiently to gain a desired thrust. The front pair of the main shafts 2 rotates in the same direction and their blades 8 become open when pointing toward the front and form a large blade to attack air. The rear pair of the main shafts 2 rotates in the same direction, but opposite to the rotation direction of the front pair, and their blades 8 become open when pointing toward the rear and form a large blade to attack air.

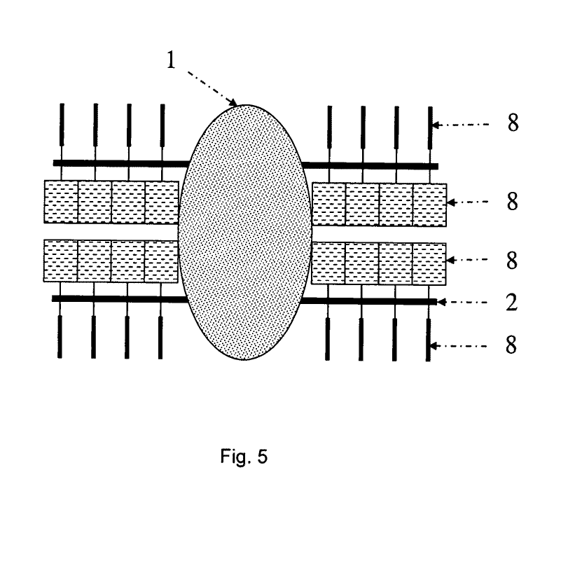

As shown in FIG. 5, each main shaft 2 carries eight blades 8. The structure of the vehicle in FIG. 5 is similar to that in FIG. 4 and both vehicles utilize the blade-combination technique. The difference is that in FIG. 5 the blades 8 on the front pair of main shafts 2 become open when pointing toward the rear and the blades 8 on the rear pair of the main shafts 2 become open when pointing toward the front. Therefore, in FIG. 5, all the blades become open when they rotates to locations close to the middle of the fuselage 1 to gain upward thrust.

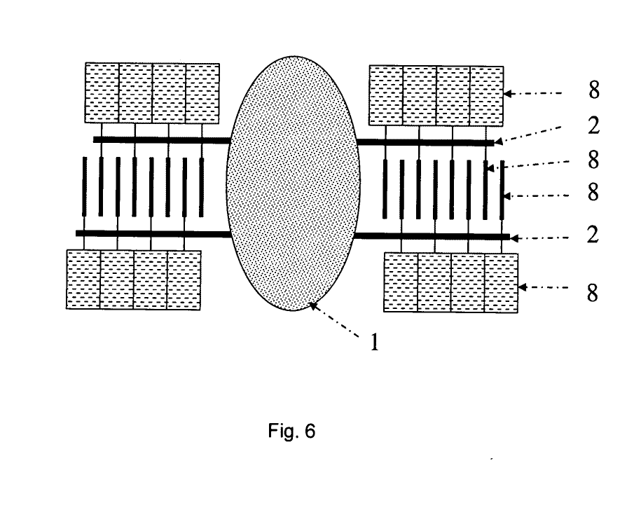

As shown in FIG. 6, each main shaft 2 carries eight blades 8. The structure of the vehicle in FIG. 6 is similar to that in FIG. 4 except that in FIG. 6 the blades 8 on the front pair of main shafts 2 and the blades 8 on the rear pair of the main shafts 2 are overlapped when they rotates to locations around the middle of the fuselage 1. This arrangement allows the blades of larger radius to be installed in a limited space.

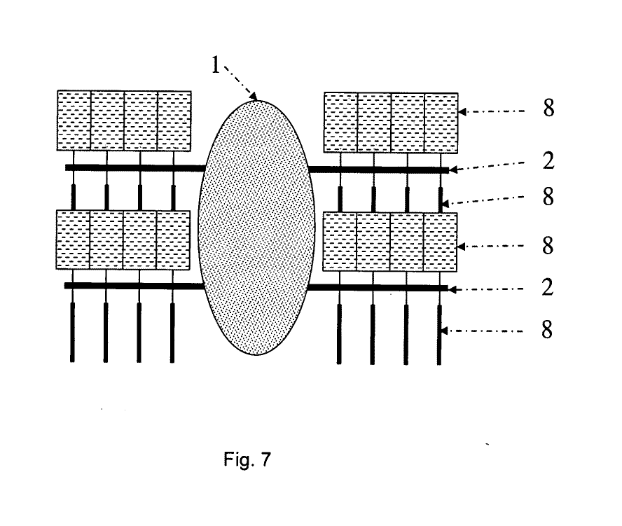

As shown in FIG. 7, each main shaft 2 carries eight blades 8. In this design, all main shafts in this vehicle rotate in the same direction. To allow the blades of larger radius to be installed in a limited space, the blades 8 on the front pair of main shafts 2 and the blades 8 on the rear pair of the main shafts 2 share the same space when they rotates to locations around the middle of the fuselage, but to avoid collision they pass the middle of the fuselage at different time.

As shown in FIG. 8, in this gear-typed blade open-close device, a main shaft 2 is installed on the fuselage 1 of a vehicle through bearing structures 10 and is driven by main engine 3. Installed on the fuselage 1 and in a plane perpendicular to main shaft 2 there are two ring segment-shaped controlling gears 4 and 11, each using main shaft 2 as the circle center and having radial teeth covering an arc region of less than 90°. A rotary handle 72 is installed on the main shaft 2 and has the controlled gear 5 fixed on it. The controlled gear 5 can be in engaged with the controlling gears 4 and 11. A gear 9 is fixed on the blade handle 7 of each blade unit and is connected with a gear that fixed on the same handle as gear 5 and spins synchronously with gear 5 through a chain-like structure, thus indirectly controlled by controlling gears 4 and 11. The teeth number of each controlling gear is one fourth of that of the gear 9 fixed on each blade handle 7.

While the blade 8 is closed, the controlled gear 5 carried by the rotating main shaft 2 driven by the main engine 3 rotates to the location of the first controlling gear 4. The controlled gear 5 will then be in mesh with and be driven by the controlling gear 4 to spin, which further drives each blade handle 7 that connected with the controlled gear to spin in or on its blade sleeve 6, causing the blade 8 fixed on each of the blade handles to spin to become open gradually. After the controlled gear 5 passes the controlling gear 4, the controlled gear 5 will no longer be engaged with controlling gear 4, thus allowing the controlled gear 4 and the connected blade handles 7 to stop spinning. By then, driven by the controlled gear 5 the blade handles 7 and the blades 8 have just spun 90° in their blade sleeves 6 and the blades are in a fully opened status. Rotating along with the main shaft 2 each opened blade 8 attacks air with its largest surface area (the area of its broad flat surface) to gain a desired thrust (it is usually a lift and/or a forward thrust, but can also be a downward and/or backward thrust if needed). After the opened blades 8 rotate a certain degree of angle, they reach the location of the second controlling gear 11 and will be driven by the second controlling gear 11 to spin 90° to get fully closed. The closed blades 8 attack air with a small area (the area of its thin side surface) and thus pass through the air with a small resistant, until they reach the location of the first controlling gear 4 again.

To make sure the blades 8 spin exactly 90° each time after passing through a controlling gear 4 or 11, it is necessary to make the teeth number of each controlling gear be one fourth of the teeth number of the gear fixed on each corresponding blade handle.

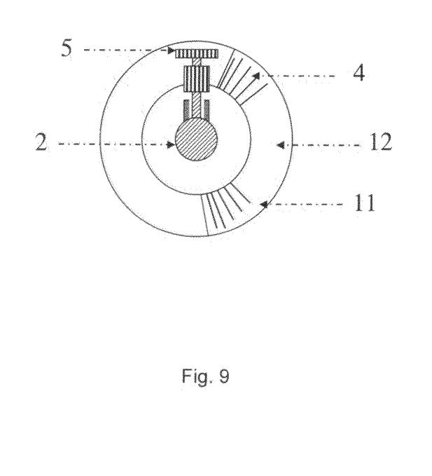

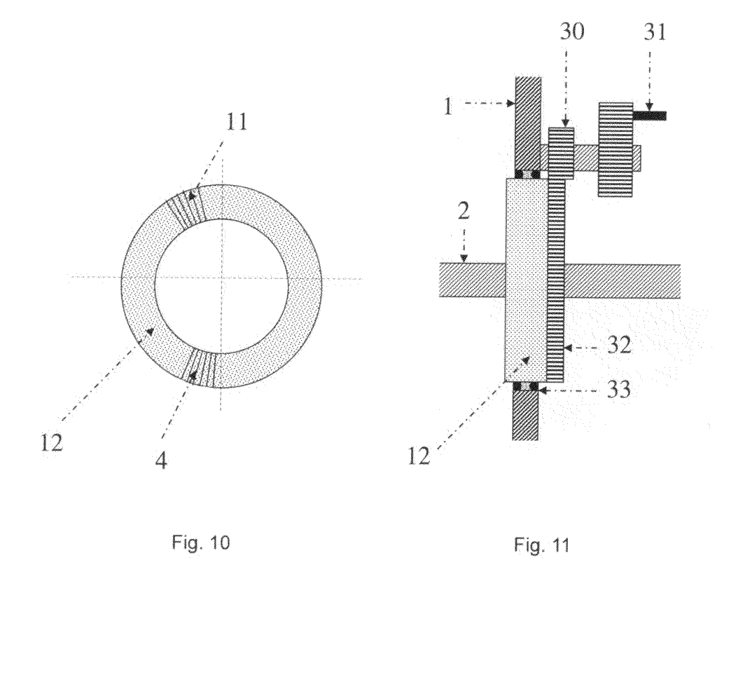

As shown in FIG. 9 and FIG. 10, the two controlling gears 4 and 11 are installed on a vertical ring 12 which uses a main shaft 2 as the circle center.

As shown in FIG. 8 and FIG. 11, the blade open-region adjuster is a vertical ring 12 using main shaft 2 as the circle center and installed on one side of fuselage 1 through a bearing structure 33. A phase gear 32 is fixed on the inner side of ring 12 and has the same circle center as ring 12 and is controlled directly (can also through a chain structure) by a driving gear 30. By rotating the driving gear 30, the phase gear 32 can be rotated and thus the position for the blades to open or close can be set. Through a manually operated rotation handle 31, the driving gear 30 can be driven to rotate. The driving gear 30 then further drives phase gear 32 to rotate, causing ring 12 and the controlling gears 4 and 11 fixed on ring 12 to rotate around the main shaft 2, and thus moving the controlling gears 4 and 11 to any desired location, which can finally adjust the position of the blade open region through the controlled gear 5.

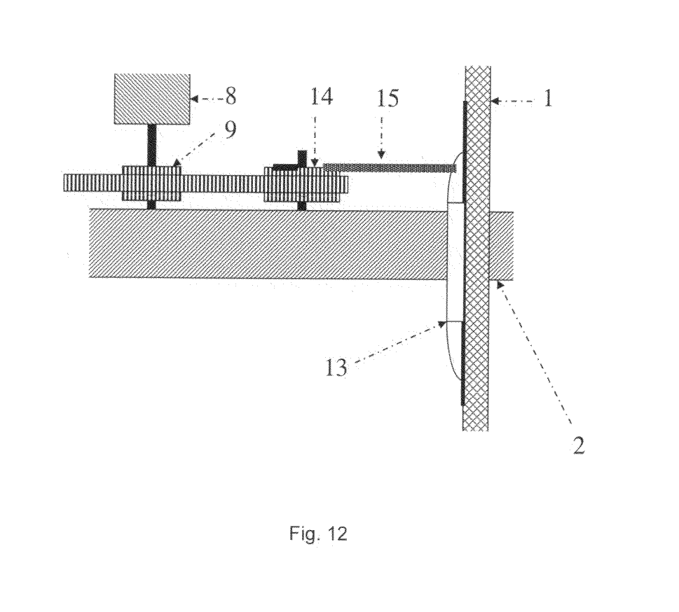

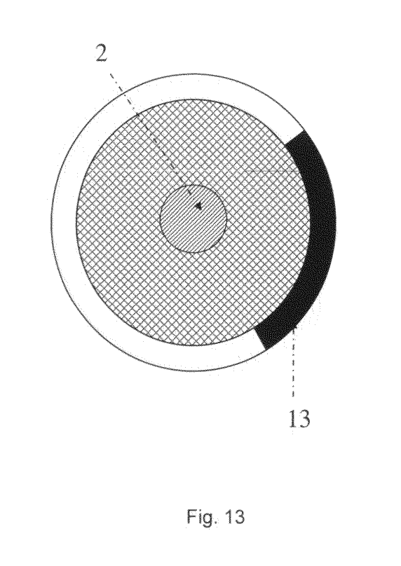

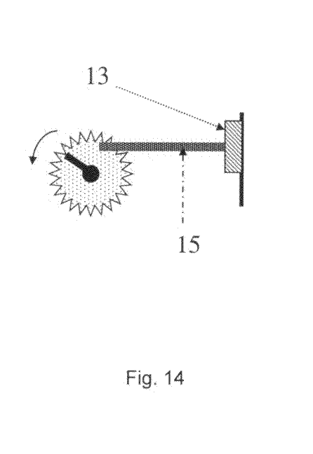

As shown in FIG. 12, FIG. 13 and FIG. 14, in an eccentric bar-typed blade open-close device, a gear 14 is installed on a main shaft 2 and is connected through a chain structure to a gear 9, which is fixed on a blade handle. One end of an eccentric pushing bar 15 is installed on an eccentric position on gear 14 and can rotate around its fixing point on gear 14. The other end of the eccentric bar 15 points toward a plane where a raised ring segment 13 using the main shaft 2 as its circle center is located. When the eccentric bar 15 carried by the main shaft 2 rotates to the location of the raised ring segment 13, one end of the bar 15 will be pushed by the raised ring segment 13 and the other end of bar 15 then pushes the connected gear 14 to rotate. The rotation of gear 14 further drives the connected blade handles and blades 8 to spin to make the blades 8 get fully opened. After passing through the raised ring segment 13, under the help of a retrieving spring not shown in the drawing or under the force of the air to the blades, the eccentric bar 15 returns to its original position and the blades return to their closed status.

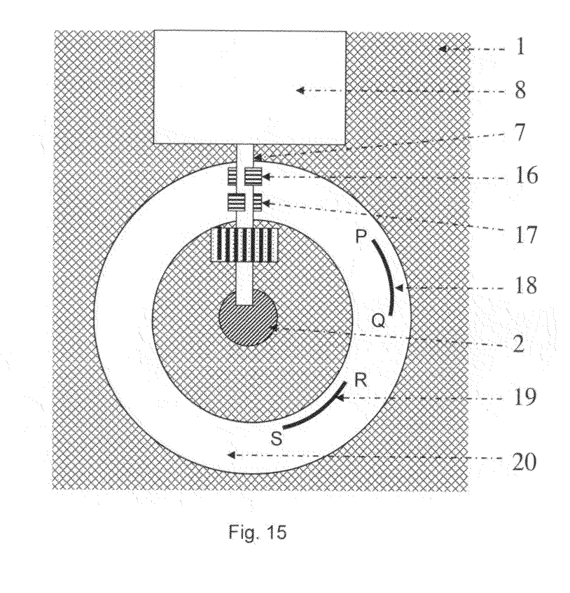

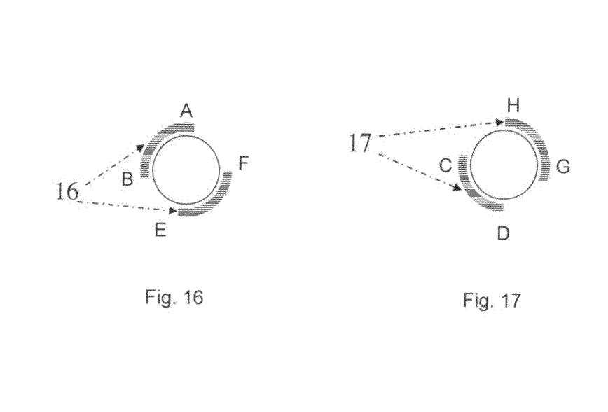

As shown in FIG. 15 to FIG. 17, in a conductive track-typed blade open-close device, the opening and closing of each blade 8 are driven by an electric motor not shown in the drawings and the circuit of the electric motor is controlled by two switches 16 and two switches 17 fixed on a blade handle 7 or on a switch handle (not shown in the drawings) which is connected with blade handle 7 through a chain structure and rotates synchronously with blade handle 7. The circuit of the electric motor is disconnected, unless the two ends of one of the switches at the same time contact the ring segment-shaped conductive track 18 or 19, which are both installed on one side of the fuselage 1, use the main shaft 2 as their circle center and are made of conductive material. The two ends of each switch are a pair of 90° (or slightly bigger than 90°) ring segments surrounding blade handle 7 and are aligned up and down with each other on blade handle 7. The two switches next to each other at left or right are located at different heights on blade handle 7 (such as switch AB and switch CD) and have a 90° phase difference between each other, while the switches facing each other across the blade handle 7 are located at the same height (such as switch AB and switch EF). There are two conductive tracks 18 and 19, both use the main shaft 2 as the center but have different radius. The two switches located at the same height and also facing each other across the blade handle 7 (a 180° phase difference) (such as AB and EF) have the same distance to the main shaft 2 as one of the conductive track 18 (P-Q) to the main shaft 2, while the other two switches located at the same height and facing each other have the same distance to the main shaft as the other conductive track 19 to the main shaft 2. The switches are installed in such a way that when one of the switches is facing its corresponding conductive track, it can contact the conductive track and make the circuit of the electric motor connected so that blade handle 7 and blade 8 can be driven to spin.

As shown in FIG. 15, a main shaft 2 rotates clockwise. The blade handle 7 carried by the main shaft 2 also rotates clockwise and has switches fixed on it directly. Conductive track P-Q controls the opening of the blades and is called opening track and its corresponding switches (AB and EF) are called opening switches. Conductive track R-S controls the closing of the blades and is called closing track and its corresponding switches (CD and GH) are called closing switches. Its working principle can be described as follows. When blade 8 is closed, one side of an opening switch AB (side A in the drawings) is facing the fuselage 1. When the blade handle 7 carried by main shaft 2 rotates to the position P where the blade is designed to start to open, the side A of the two ends of the switch AB contacts side P of the opening track P-Q, causing the circuit of the electric motor to be connected. The electric motor then through a chain or belt structure drives the blade handles to spin to start to open their blades. After the blade handle 7 has spun 90°, its blade 8 changes into a fully opened working status from a fully closed resting status. At this moment, side B of the opening switch (AB) fixed on the blade handle 7 has just spun away from the opening track P-Q, the two ends of switch AB stop contacting the opening track, the circuit of the electric motor is disconnected, the electric motor stops working and the blade 8 stays in a fully opened working status to rotate with the main shaft 2 to attack air with its largest surface area to gain a desired thrust. When the blade handle 7 and the blade 8 rotate to the position R where the blade is designed to start to close, the side C of the two ends of the switch CD contacts the closing track R-S, causing the circuit of the electric motor to be connected. The electric motor then drives the blade handles to spin to start to close their blades. After the blade handle 7 has spun 90°, its blade 8 changes into a fully closed resting status from a fully opened working status. At this moment, side D of the closing switch (CD) fixed on the blade handle 7 has just spun away from the closing track R-S, the two ends of switch CD stop contacting the closing track, the circuit of the electric motor is disconnected, the electric motor stops working and the blade 8 stays in a fully closed resting status to rotate with the main shaft 2 to pass through air with its smallest surface area, until the blade handle rotates to position P again where the blade is designed to start to close. When the blade handle 7 rotates to position P, the other opening switch (EF) starts to contact the opening track, causing the circuit of the electric motor to be connected and the electric motor to drive the blade handles to spin. After side F of the opening switch (EF) has just spun away from the opening track, the opening switch EF disconnects with the opening track, the electric motor stops rotating and the blade 8 stays in a fully opened working status. When the blade handle 7 and the blade 8 rotate to the closing position R again, the closing switch GH contacts the closing track, causing the electric motor to drive the blade handle to spin 90°. Then the closing switch GH spins away from side H and disconnects with closing track, the electric motor stops rotating and the blade stays in a fully closed resting status. A working cycle is then completed.

In theory, the two ring segment-shaped ends of each opening switch should both be 90° arcs using the blade handle 7 as their center, but in practice since the initial contact point for connecting the circuit is determined by the starting side P of the opening track, each opening switch can extend outside a little bit at its staring end (A or E). However, since the disconnection of the circuit is determined by the finishing end (B or F) of each opening switch, the finishing end (B or F) should have an exact 90° distance to the initial contact point, while the finishing side Q of the opening track can have some space to be further away from the starting side P of the track. In practice, the opening track generally needs to extend longer from its finishing side to overcome the influence of the electric motor's rotational speed variation. Similarly, the two closing switches and the closing track can extend at their staring ends and its finishing side too, respectively.

To make sure the blade handle can spin 90° each time to make the blade get fully opened from fully closed or get fully closed from fully opened, the opening track and the closing track cannot be shorter than a minimal central angle Δβₘᵢₙ. This minimal angle Δβₘᵢₙ can be calculated by the following formula.

Δβₘᵢₙ=π/2*ω_{M-sh}/ω_{m-bh}

Wherein, ω_{M-sh} is the average maximal angular rotational speed of the main shaft driven by the main engine during the period of blade opening or closing (i.e. from the time the switch starts to contact the opening (or closing) track to the time the switch starts to disconnect with the opening (or closing) track), and co_{m-bh} is the minimal angular spinning speed of the blade handle driven by the electric motor during the period of blade opening or closing

To make sure the blades can be opened or closed within a desired time in each rotation cycle, ωₘ₋ₛₕ/ω_{m-bh} should be smaller than ½. In other words, ω_{m-bh}/ωₘ₋ₛₕ should be bigger than 2. In practice, ω_{m-bh}/ω_{M-sh} should be at least 4 or even 9. From the above formula, the angular rotational speed of the main shaft can be low, but the angular spinning speed of the blade handles cannot be too low and would be better if it could be at least four folds of the average maximal rotational speed of the main shaft.

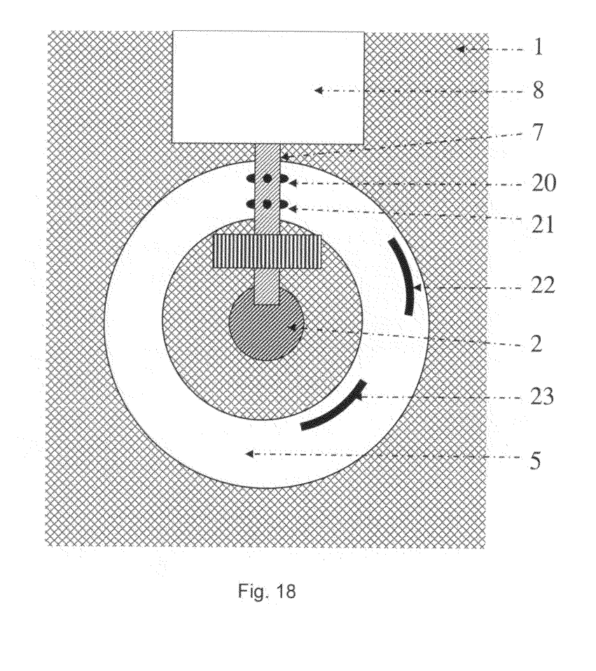

As shown in FIG. 18, in a switch-typed blade open-close device, the connection and disconnection of the circuit of the electric motor (not shown in the drawing) driving the blades 8 to open and close is controlled by switches fixed on a blade handle 7 or on a switch handle (not shown in the drawing) which is connected with blade handle 7 through a chain structure and rotates synchronously with blade handle 7. There are eight switch buttons 20 and 21 fixed on a blade handle 7. Four of them 20 are located at the same height (i.e. have the same distance to the main shaft) on the blade handle and with a 90° distance between buttons next to each other. The other four switch buttons 21 are located at another height and also have a 90° distance between buttons next to each other. The switch buttons at different height are aligned in pairs vertically (or almost vertically) along the blade handle. All these switch buttons press the same continual switch not shown in the drawing. A continual switch is a switch that can turn on and off continually when being pressed continually. In other words, if one press makes it turn on, then the next press makes it turn off, and so on. There are two ring segment-shaped pressing structures (also called pressing ring segments) 22 and 23 installed on one side of the fuselage 1, both using the main shaft 2 as their circle center but having different radius. The two radii of the pressing ring segments equal the two distances of the switch buttons to the longitudinal axis of the main shaft, respectively. When a switch button facing the pressing segments rotates to the position of the pressing ring segment that has the same distance to the main shaft as the switch button, it will be pressed by the pressing ring segment, causing the continual switch to turn on or off. The pressing ring segment located at the place to make the blade open is called opening segment 22, while the pressing ring segment located at the place to make the blade close is called closing segment 23. The switch buttons having the same distance to the main shaft as the opening segment is called opening buttons 20, while the switch buttons having the same distance to the main shaft as the closing segment is called closing buttons 21.

As shown in FIG. 18, when the blade 8 is closed and the electric motor is not rotating due to the disconnection of the circuit, there is a pair of up-and-down aligned switch buttons facing the plane of the pressing ring segments. When the switch handle along with the main shaft 2 rotates to the opening segment 22, the opening button 20 facing the opening segment and having the same distance to the main shaft as the opening segment is pressed (the closing button at different height can not be pressed and has no effect at this moment), causing the continual switch to turn on and the electric motor to drive the switch handle and the connected blade handles to spin, making the blades start to open. After the blade handles spin 90°, the blades become fully opened. At the same time the switch handle also synchronously spins 90°, causing the next pair of up-and-down aligned switch buttons to face the plane of the pressing ring segments and the opening button 20 facing the opening segment 22 and having the same distance to the main shaft 2 as the opening segment to be pressed. The press to the switch button causes the continual switch to turn off and the electric motor to stop rotating, making the blades stay fully opened to attack air to gain thrust. At the same time, the other button 21 that aligned up-and-down with this opening button and also facing the ring segment plane can not be pressed since it is located at a height different from the opening segment. When the blade handles and the switch handle along with the main shaft further rotate to the closing segment 23, the closing button 21 which has the same distance to the main shaft as the closing segment 23 and was not pressed by the opening segment 22 is now pressed by the closing segment, causing the switch to turn on, the electric motor to drive the switch handle and the blade handles to spin and the blades to start closing. After having spun 90°, the blades become fully closed and the next pair of up-and-down aligned switch buttons turns to face the plane of pressing ring segments. The closing button 21, having the same distance to the main shaft as the closing segment 23, in this pair is then pressed by the closing segment 23, causing the continual switch to turn off and the electric motor to stop rotating, thus making the blades stay fully closed to pass through the air, until the blade handle and the switch handle along with the main shaft rotate to the opening segment again to repeat the above process.

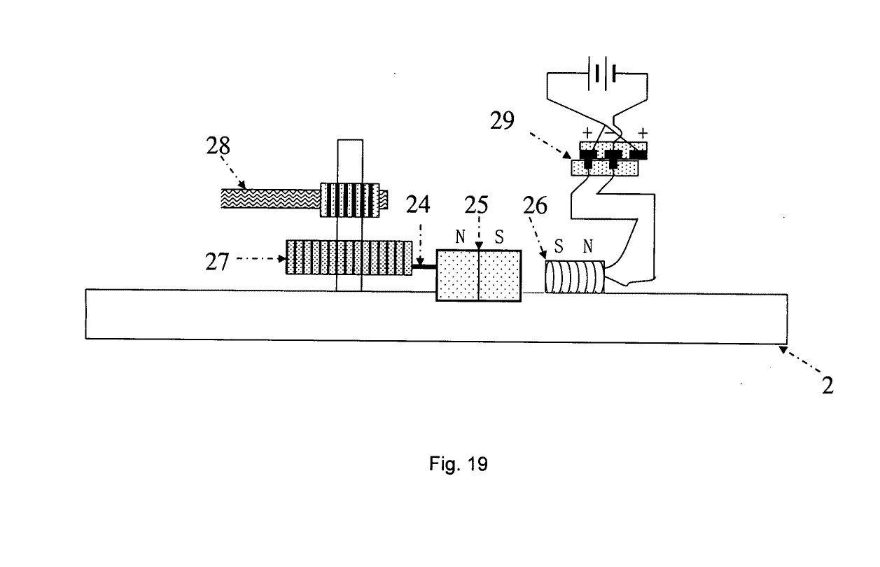

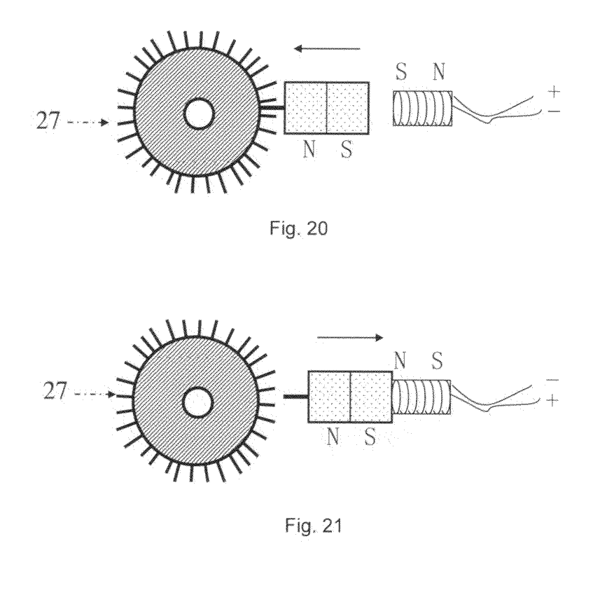

As shown in FIG. 19 to FIG. 21, in an electromagnet-typed blade anti-free spinning device, the anti-free spinning key 24 is fixed on a magnet 25 and can only move at one dimension along its length on the main shaft 2. One end of the anti-free spinning key is connected with an end of the magnet 25 whose the other end is close to an electromagnet 26. The other end of the anti-free spinning key is close and points to an anti-free spinning gear 27 fixed on a blade handle (or on a switch handle connected with the blade handle through a chain-like structure 28, or on the shaft of the electric motor not shown in the drawing). At one electric current direction, the electromagnet 26 can produce a magnetic field to attract the anti-free spinning key to move toward the electromagnet and away from the anti-free spinning gear 27 fixed on the blade handle (or switch handle or electric motor shaft), causing the key to be out of touch with the gear 27 and thus allowing the gear 27 and the blade handles and the blades to spin. When the direction of the electric current is reversed by a direction-changing switch 29, the electromagnet will reverse its poles and produce a magnetic field to push the anti-free spinning key to move away from the electromagnet and toward the anti-free spinning gear 27, causing the key to insert into the gear 27 and thus preventing the gear and also the blade handles and blades from spinning.

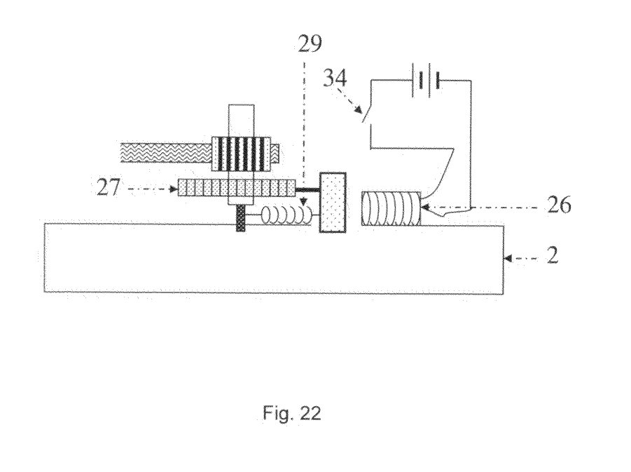

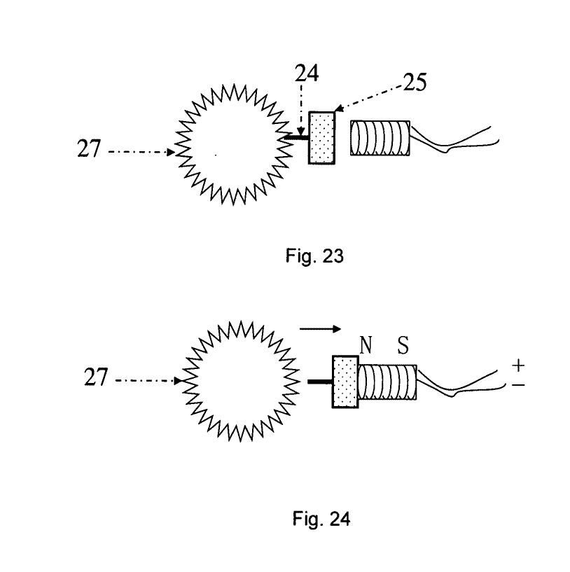

As shown in FIG. 22 to FIG. 24, in an electromagnet and spring combined blade anti-free spinning device, the anti-free spinning key 24 is driven by a combination of a spring 29 and an electromagnet 26. The anti-free spinning key 24 is fixed on a magnet 25 and can only move at one dimension along its length on the main shaft 2. One end of the anti-free spinning key is connected with an end of magnet 25 whose the other end is close to an electromagnet 26. The other end of the anti-free spinning key is close and points to an anti-free spinning gear 27. When the switch 34 of the circuit of the electromagnet 26 gets connected, the electromagnet 26 can attract the anti-free spinning key 24 to move toward the electromagnet and away from the anti-free spinning gear 27, causing the key to be out of touch with the gear 27 and thus allowing the gear 27 and the blade handles and blades to spin. When the switch 34 of the circuit of the electromagnet 26 is disconnected, the retrieving spring 29 can pull the anti-free spinning key back to insert it into the anti-free spinning gear 27 and thus preventing the anti-free spinning gear and also the blade handles and the blades from spinning.

What is claimed is:

1. A vehicle capable of moving on land, in air and/or in water comprises at least a fuselage, a main engine or a main electric engine and a power control and transmitting system; said vehicle having the characteristic of: on the two sides of said fuselage there are main shafts stretching out, said main shafts having blade sleeves fixed thereon, said blade sleeves having blade handles installed therein/thereon in a way that said blade handles can spin on own central axes, said blade handles having blades fixed thereto, said fuselage and/or said main shafts having blade open-close devices installed thereon to control the spinning of said blade handles and said blades relative to said blade sleeves and said main shafts; and wherein said blade open-close devices are mechanisms that can open and close said blades once during each cycle said blades rotate along with said main shafts, wherein when said blades are opened, said blades' broad flat surfaces are parallel or nearly parallel with said main shafts, and when said blades are closed, said blades' broad flat surfaces are vertical or nearly vertical to said main shafts.

2. A vehicle as claimed in claim 1, wherein said blade open-close devices comprise at least controlled gears and controlling gears, said controlled gears being gears fixed on said blade handles or being gears connected with the gears fixed on said blade handles through chain-like structures, said controlling gears being teethed rings surrounding and perpendicular to main shafts and installed on said fuselage and each having teeth covering a whole circle, and wherein said controlled gears are engaged with said controlling gears, and the teeth number of each said controlling gear is one second of that of its corresponding gear fixed a blade handle.

3. A vehicle as claimed in claim 1, wherein said blade open-close devices comprise at least controlled gears and controlling gears, said controlled gears being gears fixed on said blade handles or being gears connected with the gears fixed on said blade handles through chain-like structures, said controlling gears being teethed ring segments installed on said fuselage and perpendicular to said main shafts, and wherein when said blades rotating along with said main shafts pass one of said controlling gears, one of said controlled gears can contact and be engaged with this controlling gear, and the teeth number of each controlling gear is one fourth of that of its corresponding gear fixed on a blade handle.

4. A vehicle as claimed in claim 1, wherein each said blade open-close device comprises at least a gear fixed on one of said blade handles; a pushing bar fixed at and being rotatable around an eccentric point on this gear or on a gear that, through a chain-like structure connects with this gear; and a raised ring segment installed on one side of the fuselage; and wherein when rotating to the position of said raised ring segment, one end of said pushing bar can contact with said raised ring segment.

5. A vehicle as claimed in claim 1, wherein said blade open-close device comprises at least an electric motor or electromagnet; one or two or more than two ring segment-shaped parallel switches controlling the circuit of said electric motor or electromagnet and fixed on a blade handle or on a switch handle that connects with this blade handle through a chain-like structure and rotates with this blade handle; and ring segment-shaped conductive tracks made of conductive material and installed on one side of the fuselage; and wherein when the blade handle or the switch handle rotates to the location of one of said conductive tracks, the switch facing this conductive track can contact the conductive track and make the circuit of the electric motor or electromagnet connected.

6. A vehicle as claimed in claim 1, wherein each said blade open-close device comprises at least an electric motor or electromagnet; one or two or more than two switch buttons controlling said electric motor or electromagnet and fixed on a blade handle or on a switch handle that connects with blade handles through a chain-like structure and rotate with blade handles; and pressing ring segments or pressing bars using a main shaft as their circle center and installed on one side of the fuselage; and wherein when the switch handle rotates to the location of one of said pressing ring segments or one of said pressing bars, the switch button facing this pressing ring segment or pressing bar can contact this pressing ring segment or this pressing bar, making the circuit of the electric motor or electromagnet change its connection status or its current direction.

7. A vehicle as claimed in claim 1, wherein each said blade open-close device comprises at least an electric motor or electromagnet; one or two or more than two light-inducible (or sound-inducible) parallel switches or one or two or more than two light-receiving (or sound-receiving) windows of a ling-inducible (or sound-inducible) switch controlling the circuit of said electric motor or electromagnet and fixed on a blade handle or on a switch handle that connects with a blade handle through a chain-like structure and rotates with this blade handle; and light-producing (or sound-producing) ring segments fixed on one side of the fuselage; and wherein when the switch handle along with a main shaft rotates to one of the light-producing (or sound-producing) ring segments, a light-inducible (or sound-inducible) switch or a light-receiving (or sound-receiving) window of a switch can receive the inducing signal produced by the light-producing (or sound-producing) ring segment, making the circuit of said electric motor or electromagnet get connected.

8. A vehicle as claimed in claim 1, wherein said fuselage has two or more than two main shafts, wherein the blades on some of said main shafts open in an angle region surrounding a horizontal plane and by adjusting the rotational speed and direction of these main shafts the magnitude and direction of the vertical thrust can be controlled, while the blades on some other main shafts open in an angle region surrounding a vertical plane and by adjusting the rotational speed and direction of these main shafts the magnitude and direction of the horizontal thrust can be controlled.

9. (canceled)

10. (canceled)

11. (canceled)
